(19) United States
(12) Patent Application Publication
(10) Pub. No.: US 2018/0300660 A1
(43) Pub. Date: Oct. 18, 2018

(54) SYSTEMS AND METHODS FOR PROVIDER CLAIMING AND MATCHING OF SCHEDULED REQUESTS

(71) Applicant: Lyft, Inc., San Francisco, CA (US)

(72) Inventors: Kassandra Coan, San Francisco, CA (US); Danial Afzal, San Francisco, CA (US); Brady Andrew Law, San Francisco, CA (US); Robert J. Person, Seattle, WA (US); Drew Trager, San Francisco, CA (US)

(21) Appl. No.: 15/955,603

(22) Filed: Apr. 17, 2018

Related U.S. Application Data
(60) Provisional application No. 62/486,933, filed on Apr. 18, 2017.

(51) Int. Cl. G06Q 10/06; G06Q 10/02; G08G 1/00; H04W 4/029

(52) U.S. Cl. CPC G06Q 10/06311; H04W 4/029; G08G 1/202; G06Q 10/02

(57) ABSTRACT

Embodiments provide techniques, including systems and methods, for allowing providers to claim scheduled rides. For example, a provider (e.g., a driver) may review and claim scheduled rides through a scheduled rides interface before the scheduled ride is ready to be provided. The scheduled rides provided through the scheduled ride interface may be limited to those requests that are associated with areas and times that have a lower chance of successfully being matched at the request time. Accordingly, scheduled requests may be filtered from a real-time scheduled ride feed based on the chance of successfully matching a scheduled ride at the time of the request and may be targeted to candidate providers for review and claiming by the candidate providers.

### CROSS-REFERENCE TO RELATED APPLICATIONS

This application claims the benefit of and priority to U.S. Provisional Application No. 62/486,933, filed Apr. 18, 2017, the entire contents of which are hereby incorporated by reference.

### BACKGROUND

Traditionally, people have requested and received services at fixed locations from specific service providers. For example, various services were fulfilled by making a delivery to a user at a home or work location. Many services can now be accessed through mobile computing devices and fulfilled at arbitrary locations, often by service providers that are activated on demand. Such on-demand service offerings are convenient for users, who do not have to be at fixed locations to receive the services. Additionally, on-demand service matching systems may select and provide requests to service providers based the location and status of service providers near a request location. Accordingly, on-demand matching systems may monitor system resources and control efficient resource allocation based on demand-matching between requestors and providers distributed through a geographic area.

However, as such services have become more prevalent, and more users are interacting with such services across many different geographic and demographically diverse regions, it can be difficult to match requests in different areas with different population densities, numbers of requestors, numbers of providers, and levels of activity. For example, geographic regions with smaller numbers of people or with fewer transportation demands may be more difficult to consistently match requests with providers in an area. Accordingly, requestors in such an area may not be able to match with a provider within a reasonable amount of time or at their requested time. This leads to inefficient resource allocation within the ride matching system as the inability to match requests at underserved locations leads to canceled requests by requestors, inefficient travel by providers, and duplicated requests by requestors.

### BRIEF DESCRIPTION OF THE DRAWINGS

Various embodiments in accordance with the present disclosure will be described with reference to the drawings, in which:

FIG. 1 illustrates an example of a ride matching system including a matched provider and requestor, in accordance with an embodiment of the present techniques;

FIG. 2 illustrates an example of a ride matching system environment showing request matching rates and a number of available providers in different regions, in accordance with an embodiment of the present techniques;

FIGS. 3A-3D illustrate example interfaces of a provider computing device allowing a provider to claim a scheduled request from a requestor, in accordance with an embodiment of the present techniques;

FIG. 4 illustrates an example block diagram of a dynamic transportation matching system, in accordance with an embodiment of the present techniques;

FIG. 5 illustrates an exemplary flow diagram of a method for filtering scheduled ride requests to one of a plurality of request feeds, in accordance with embodiments of the present techniques;

FIG. 6 illustrates an exemplary flow diagram of a method for matching a scheduled ride request as a ride time approached, in accordance with embodiments of the present techniques;

FIG. 7 illustrates an example requestor/provider management environment, in accordance with various embodiments;

FIG. 8 illustrates an example data collection and application management system, in accordance with various embodiments;

FIGS. 9A-9C illustrates an example provider communication device in accordance with various embodiments; and

FIG. 10 illustrates an example computer system, in accordance with various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments of the present disclosure provide techniques, including systems and methods, for matching providers with scheduled requests and specifically are directed to providing an interface allowing providers to accept and match scheduled rides before it is time to provide the scheduled rides. For example, a provider (e.g., a driver) may review and claim scheduled rides through a scheduled rides interface before the scheduled ride is ready to be provided. The scheduled rides provided through the scheduled ride interface may be limited to those requests that are associated with areas and times that have a low chance of successfully being matched at the request time. Accordingly, scheduled requests may be filtered from a real-time scheduled ride feed based on the chance of successfully matching a scheduled ride at the time of the request and may be targeted to candidate providers for review and claiming by the candidate providers. Thus, scheduled request that have a low chance of success may be filtered from a real-time matching feed to a scheduled rides feed that allows providers to review and claim scheduled requests to increase the chance of finding a provider for a request.

Scheduled rides allow requestors to request a ride that is scheduled for a particular time and location in the future. Traditionally, such rides would be matched similarly to on-demand or real-time ride requests and at predetermined time before the scheduled ride, a request may be issued for the ride. However, some areas do not have consistent provider demand and/or such requests can lead to long travel times and driver downtime for any providers to travel to the pick-up location. Accordingly, embodiments are directed to improved methods of matching scheduled rides with available drivers by allowing providers to claim scheduled rides through a scheduled rides interface.

According to some embodiments, a matching system may determine average successful match rates for a scheduled time and location of a requested ride. Embodiments may determine whether the scheduled ride should be moved to a scheduled ride pool that is separate from an on-demand request pool. For example, for requests that are likely to be unsuccessfully matched at the time of the scheduled ride, the request can be moved to a scheduled ride pool. Drivers may be notified of available scheduled rides and can review and accept scheduled rides from a list of available scheduled rides. The list of rides may be targeted to the drivers based on their residence, historical ride activity, and/or any other relevant timing and geographic location information associated with the drivers.

Overlapping scheduled rides may be filtered from review by the driver and the available scheduled rides may be ranked according to ride value to the driver. In some embodiments, the scheduled ride value may be based on the price to be paid for the ride as well as convenience to a provider. Accordingly, by allowing providers to pre-arrange and schedule pick-ups in a separate scheduled ride pool that is filtered and targeted for drivers, embodiments minimize canceled and denied on-demand ride requests, minimize driver downtime and travel time to request locations, and increase the overall efficiency of the ride matching system.

Additionally, embodiments may use predicted provider availability and matching time for an area associated with a scheduled request to determine whether to allow claiming by providers or to match the request using a real-time on demand matching to a closest provider. Further, by allowing hard to match requests to be claimed by providers, embodiments use existing provider resources more efficiently as providers that may otherwise travel to a higher demand area with more known requests may use their travel time more efficiently by taking one or more requests that may be on the way to those areas. Accordingly, embodiments more efficiently match requestors and providers for requests in areas with more inconsistent provider resources. This minimizes lost downtime for providers and results in increased throughput for provider resources within the matching system.

Moreover, embodiments conserve system resources by more efficiently managing difficult to match requests. For example, when such requests are attempted to be matched, a ride matching system may contact a large number of providers by sending matching requests to a large set of available providers that are closest to the request. The providers may accept or decline such requests and when the request location is far from a current location of a provider, a large number of available providers may be sent requests where each provider declines the request because the amount of travel required to get to the request location does not make sense for the provider compared to the value of the service provided.

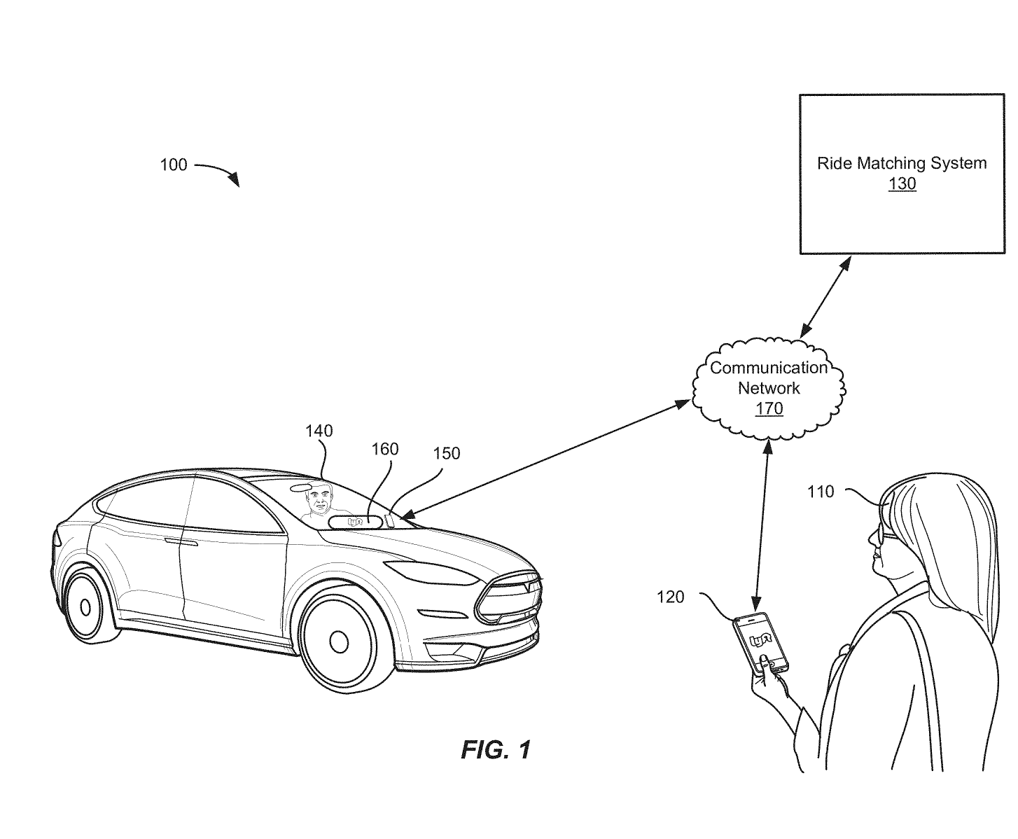

FIG. 1 illustrates an example of a ride matching system 130 including a matched provider 140 and requestor 110, in accordance with an embodiment of the present techniques. The ride matching system 130 may be configured to communicate with both the requestor computing device 120 and the provider computing device 150. The provider computing device 150 may be configured to communicate with a provider communication device 160 that is configured to easily and efficiently display information to a provider 140 and/or a requestor 110. The requestor 110 may use a ride matching requestor application on a requestor computing device 120 to request a ride at a specified pick-up location. The request may be sent over a communication network 170 to the ride matching system 130. The ride request may include transport request information that may include, for example, a request location, an identifier associated with the requestor and/or the requestor computing device, user information associated with the request, a location of the requestor computing device, a request time (e.g., a scheduled ride may have a future time for the request to be fulfilled or an “instant/current” time for transportation as soon as possible), and/or any other relevant information to matching transport requests with transport providers as described herein. The request location may include, for example, a current location, a future location, a “best fit/predictive” location, a curb segment, or any other suitable information for indicating a location for a requestor to be found at the current time or in the future. In some embodiments, the transport request may further include other request related information including, for example, requestor transport preferences (e.g., highway vs. side-streets, temperature, music preference (link to 3^{rd} party music provider profile, etc.), personalized pattern/color to display on provider communication device, etc.) and requestor transport restrictions (e.g., pet friendly, child seat, wheelchair accessible, etc.).

The requestor computing device 120 may be used to request services (e.g., a ride or transportation, a delivery, etc.) that may be provided by the provider 140. The provider computing device 150 may be used to contact available providers 140 and match a request with an available provider 140.

The ride matching system (also referred to as a “dynamic transportation matching system”) 130 may identify available providers that are registered with the ride matching system 130 through an application on their provider computing device 150. The ride matching system 130 may send the ride request to a provider computing device 150 and the provider 140 may accept the ride request through the provider computing device 150. Additionally and/or alternatively, in some embodiments, the provider may be predictively and/or may be automatically matched with a request such that the provider may not explicitly accept the request. For instance, the provider may enter a mode where the provider agrees to accept all requests that are sent to the provider without the ability to decline and/or review requests before accepting. In either case, the provider computing device may return information indicative of a match indicating that the provider received the transport request. For example, the information indicative of a match may include a provider accept indicator (e.g., a flag) that indicates the provider received and accepts the indicator or could include a variety of different information. For instance, the information indicative of a match may include location information, other route information for other passengers in the vehicle, a list of claimed requests in the future for the provider providing information regarding future availability (e.g., other claimed rides that have been pre-arranged, when the provider has indicated they are going to go offline, etc.), diagnostics associated with the car (e.g., gas level, battery level, engine status, etc.), and/or any other suitable information.

The provider 140 and the requestor 110 may be matched and both parties may receive match information associated with the other respective party including requestor information (e.g., name, representative symbol or graphic, social media profile, etc.), provider information (e.g., name, representative symbol or graphic, etc.), request location, destination location, respective computing device location, rating, past ride history, any of the other transport request information and/or provider acceptance information identified above, and/or any other relevant information for facilitating the match and/or service being provided. Thus, the ride matching system 130 may dynamically match requestors and providers that are distributed throughout a geographic area.

Further, in some embodiments, the ride matching system may be configured to receive scheduled requests for a future time or date from a request computing device. Accordingly, the requestor may set a request time and a request location in the future where they desire to have a service provided. Accordingly, the ride matching system 130 may allow a requestor 110 to request a scheduled ride using a requestor application on the requestor computing device 120. The ride matching system may schedule a time to issue a match request for a scheduled request based on the request time of the scheduled request. However, depending on the request location and the request time of the scheduled request, it may be difficult to find an available provider for a request at the scheduled request time. For example, a requestor may make a request in an area where fewer requests are received and where available providers do not tend to accept requests and/or tend not to travel to in order to get requests. Thus, the area may have an inconsistent supply of available drivers at a scheduled request time.

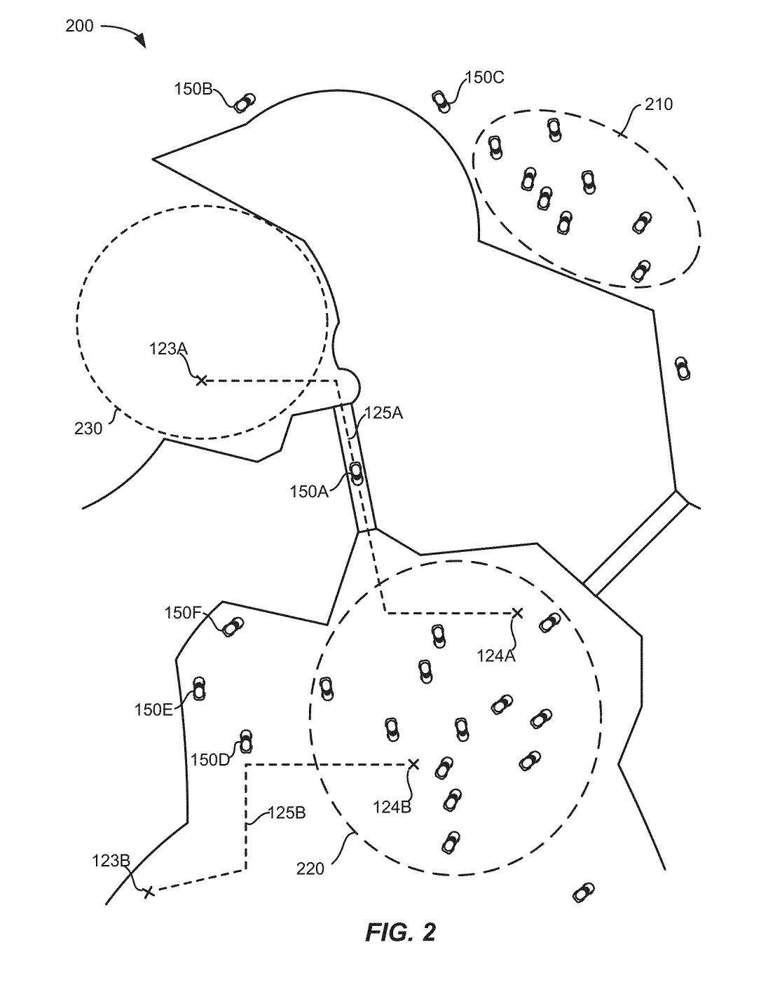

FIG. 2 illustrates an example of a ride matching system environment 200 showing different regions 210-230 with different request matching rates and different numbers of available providers 150A-150N, in accordance with an embodiment of the present techniques. The provider computing devices 150A-150N may only include those providers that are “available” meaning that they have at least one seat open to be potential matches with the request. Further, in some embodiments, the request may have further criteria that limit the number of available providers for the request. For example, car seats, pet friendly, and/or particular sizes or types of vehicles may be used to limit the number of “available” providers for the request.

As can be seen in FIG. 2, a number of available providers at any given time may fluctuate between regions based on where requestors tend to issue a large number of requests. The density of requests may be associated with areas where people work (e.g. downtown areas where people commute for work), visit (e.g., museums, venues, airports, and/or other attractions where people may need services), live (e.g., dense housing areas where more people live may have higher request demands), and/or based on availability of parking within a region (e.g., areas with limited parking availability may require more transportation services). For example, some areas have relatively large numbers of available providers 150A-150N while other areas do not. For instance, area 210 and area 220 have more available providers within them than area 230. It is likely that area 210 and area 220 have more demand for services and more corresponding requests in those areas. Accordingly, available providers know where these areas are and tend to travel to these areas to match with requests and be able to provide services. As such, many times providers live in lower request areas (e.g., rural or suburban areas) and travel to higher request areas in order to be matched with requestors for services.

For example, available provider 150A may be traveling from the lower request density area 230 to the higher request density area 220. The available provider may be traveling to the higher request density area 220 because they believe that the best chance for matching a request is in those areas. While that may be true for any given time of the day, some requests may still be sent from requestors in the lower request density area 230. For example, as can be seen in FIG. 2, a requestor has requested a request at a request location 123A within the lower request density area 230. Further, the request has a destination location 124A within the higher request density area 220 and has a travel route 125A that is similar to the travel path of the available requestor 150A. Accordingly, the available provider 150A may have been able to match with the requestor 110 had they known the request was coming.

Instead, when the requestor 110 submits a request through their requestor computing device 120, a ride matching system may attempt to match the request with available providers in the area. However, as can be seen in FIG. 2, there are no available providers in the vicinity of the request location. Accordingly, the ride matching system may attempt to match the request with the closest available providers by sending matching requests to their provider computing device 150. For example, the ride matching system may send a request to the available provider 150A because they are closest to the request location. However, the available provider 150A may not be interested in accepting the ride request because they are already on their way to higher request density area 220 and they cannot easily turn around and travel to the request location 123A without losing travel down time. As such, the available provider may decline the match request. The ride matching system may then determine the second closest available provider and send a request to available provider 150B. However, available provider 150B may also decline the request because they are a long distance from the request and the request destination is in a different direction from the higher request density area 210 they are likely traveling to. Accordingly, the second available provider 150B may also decline the request and the ride matching system may receive the decline message from the provider computing device associated with the second available provider. This process may continue for a third available provider 150C as well as many more available providers 150D-150N. Accordingly, the ride matching system may issue a large number of matching requests to each of a large number of available providers, all of which do not accept the ride request. As such, the request may not be able to be matched and the requestor may have to find another solution for the service or may have to wait for a long travel time for one of the available providers that eventually accepts the request.

Similarly, a second request associated with a second request location 123B that is received from a second requestor computing device (not shown) may have a similar problem even though the second request is not in a designated lower request density location. For example, the ride matching system may send matching requests to multiple available providers 150D-150F before one of the available providers is willing to accept the ride request. Even if the request is eventually accepted by one of the available providers 150D-150F, there will be delay for the requestor as an available provider travels to the request location and the provider has down time they are not being compensated for by traveling to the request location. Accordingly, system resources are wasted by requiring large numbers of requests and responses to be sent to different providers in order to find an available provider willing to travel to a request location and requestors may be frustrated by the amount of time required to obtain a service.

However, embodiments may address these problems as well as other problems by allowing providers to review scheduled requests that are targeted to them before it is time to provide services associated with the requests and allow the providers to claim requests that may be matched with them at the appropriate request time. The scheduled request that are shown to providers may be filtered to only those areas that may have trouble matching a requestor based on historical request matching rates and/or numbers of available providers for a scheduled request time. Further, the scheduled rides present to a provider may be filtered to ensure the request is relevant to the activity and/or behavior of the provider.

Accordingly, embodiments provide techniques to filter scheduled requests in low request density areas to a scheduled ride feed that allows providers to review and claim scheduled requests before the requests are due to be processed or acted upon. As such, providers may claim scheduled rides in areas with inconsistent supply of available providers to increase the effectiveness and speed of matching providers in these areas. Allowing providers to claim such requests ensures the most efficient matching leading to the least amount of provider downtime and the most possible throughput by the ride matching system. Further, system processing resources are conserved as the ride matching system does not have to issue multiple low probability requests to available providers far from a request location looking for an available provider that may be willing to travel to a long distance to a request location.

In addition, the ride matching system 130 can determine areas that are for scheduled rides only. In other words, the ride matching system 130 can designate geographic areas where there is low requestor demand as areas where on-demand ride matching is unavailable. To illustrate, the ride matching system 130 can monitor geographic areas to determine a number of ride requests received from a particular area over a given period of time. In response to determining that the ride matching system 103 receives a number of request from the particular area that does not satisfy a request threshold, the ride matching system 130 designates the particular area as one where on-demand matching is unavailable for requestors.

In some embodiments, the ride matching system 130 can further base the determination of areas where on-demand ride matching is unavailable on other factors such as an average number of available providers near (e.g., within a threshold distance of) the area, average ETA to pick-up locations within the area, average value of requests within the area, and/or average ride time for ride requests received from the area. Indeed, the ride matching system 130 can enable or disable on-demand matching based on the various factors set forth herein. Thus, for a given area where on-demand matching was once unavailable, the ride matching system 130 can determine that, based on the factors such as ETA, value, etc., on-demand matching for the area would be viable. Based on this determination, the ride matching system 130 can enable on-demand matching for the area.

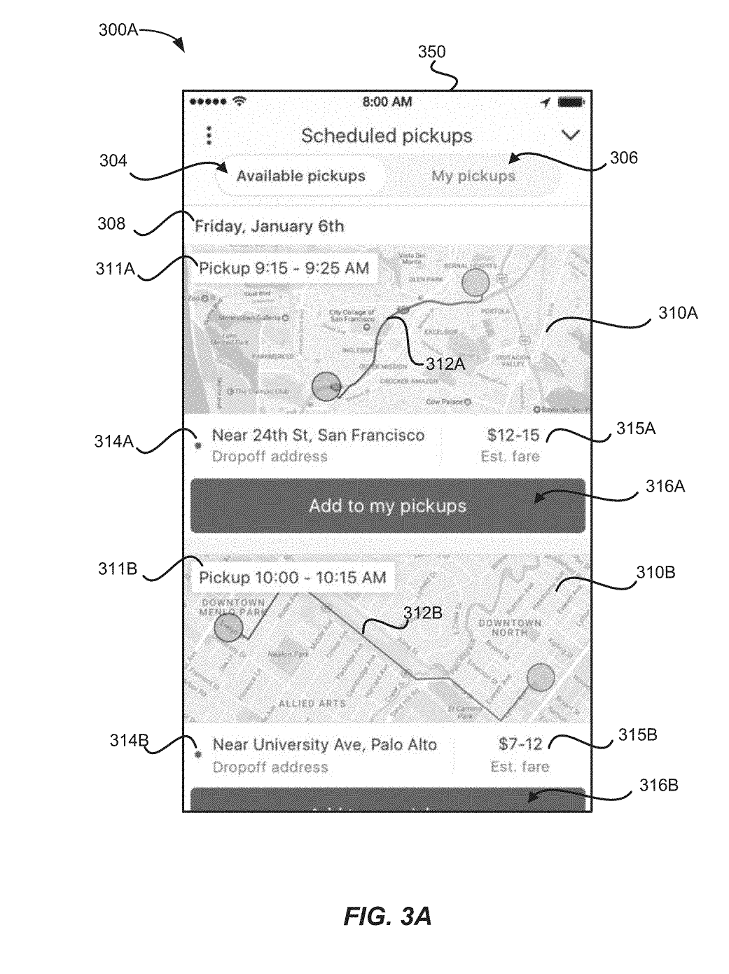

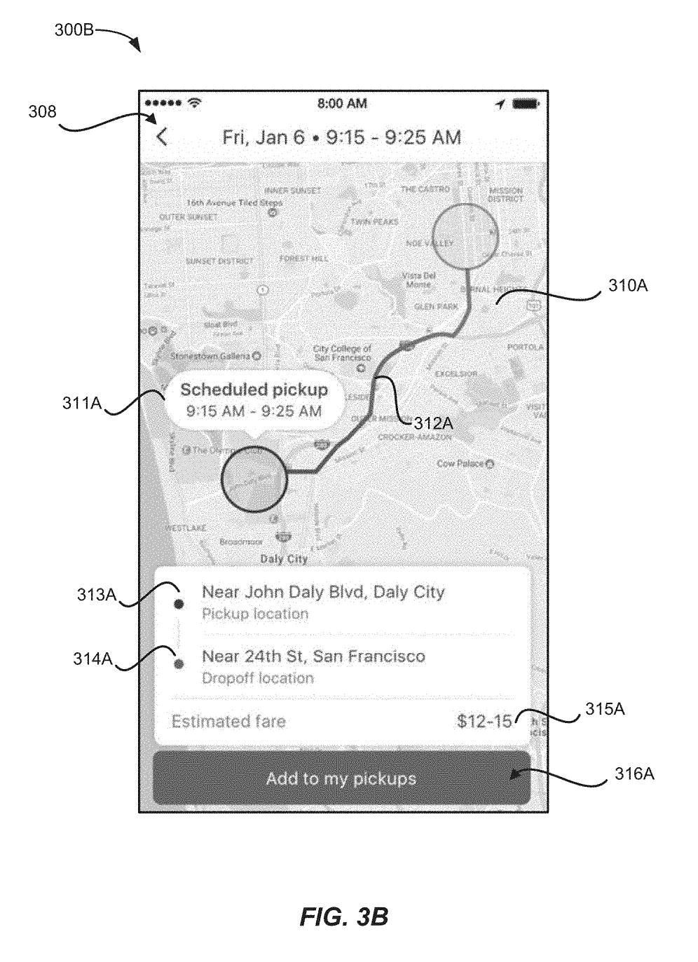

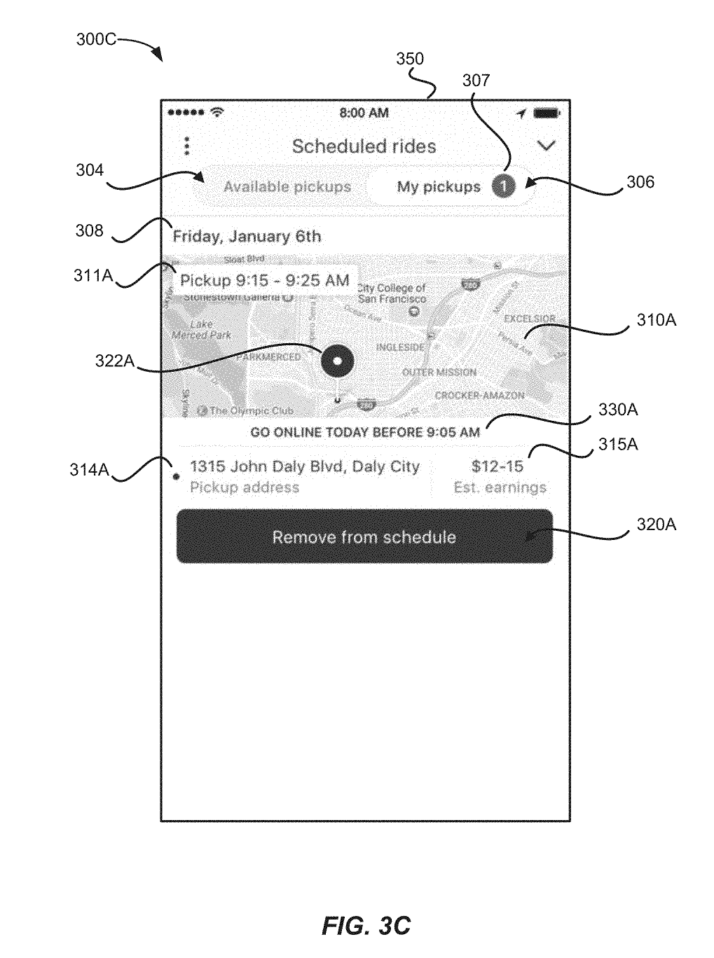

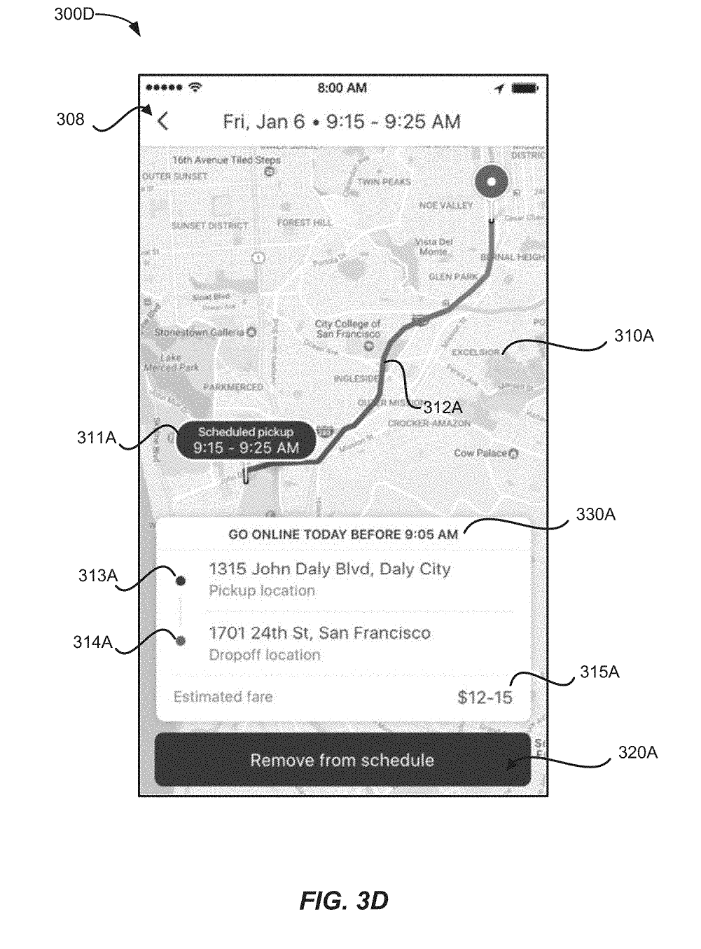

FIGS. 3A-3D illustrate example interfaces 300A-300D of a provider computing device 350 allowing a provider to claim a scheduled request from a requestor, in accordance with an embodiment of the present techniques. FIG. 3A shows available requests (e.g., “available pickups”) that may be presented to a provider through an available scheduled request interface 300A. The available scheduled request interface 300A may be accessed through a provider application operating on a provider computing device 350 of a provider. The available scheduled request interface may include one or more available scheduled requests 310 that may be claimed or pre-arranged by a provider before a service associated with the request is due to be provided. The available scheduled request interface 300A may include a day indicator 308 and a time indicator 311A-B for the available scheduled requests 310A-310B. Any number of available scheduled requests may be presented through the interface. For example, the interface shown in FIG. 3A shows two different available scheduled requests 310A-310B. However, the interface may be interactive such that the provider may scroll down to see additional available scheduled requests (not shown). Each of the available scheduled requests may include a request time 311A and a route 312A for the scheduled request including a general request location and a general destination location for the scheduled request. The route may be presented in a map interface such that the provider may easily identify where in the region or area the request location and destination location for the scheduled request. Additionally, a nearby destination address 314A or pickup address may be presented along with an estimated fare value 315A associated with the request. Accordingly, the provider may quickly, easily, and intuitively review multiple scheduled requests that are relevant to them.

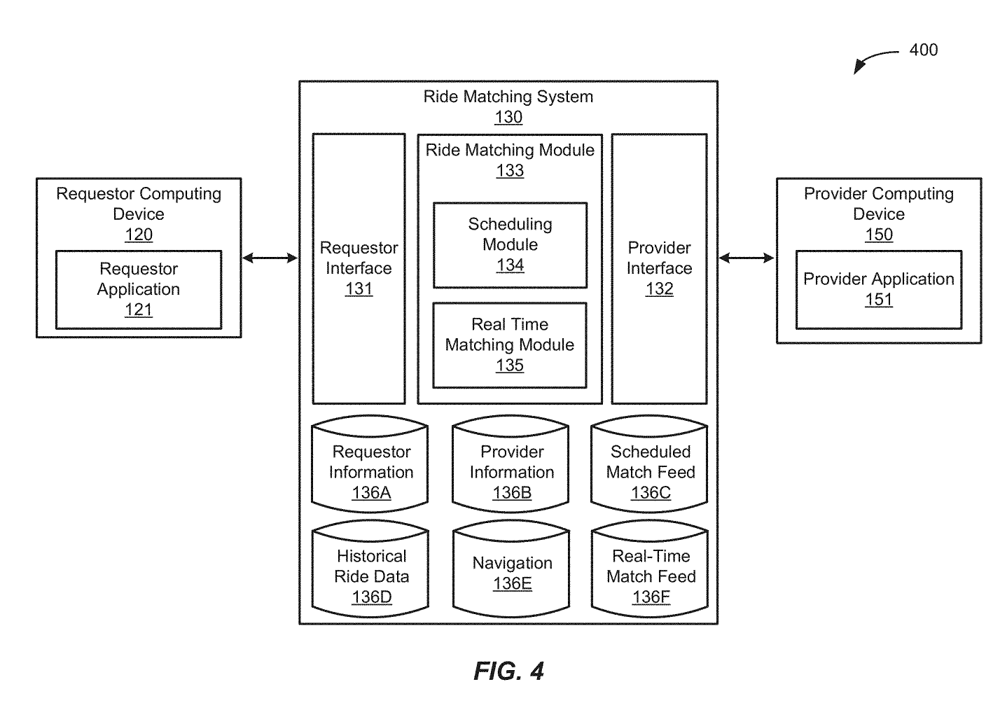

Additionally, each available scheduled request 310 may have an “add to my pickups” button 316A (also referred to as an interactive element) that may allow the provider to claim the available scheduled request and add the available scheduled request to a queue of scheduled requests that have been claimed by the provider. The add button 316A may associate the scheduled request with the provider. Once a scheduled request is associated with a provider, the ride matching system may match the scheduled request with the provider as long as the provider is available and able to meet the request constraints associated with the scheduled request. Additional details regarding the matching of the scheduled request with the claimed provider will be provided below in reference to FIGS. 4-6.

Moreover, the available scheduled ride indicator may also be interactive such that if the provider selects the available scheduled request information by selecting the interactive map element 310A, additional details may be provided for further review of the presented map and/or request details. Accordingly, FIG. 3B shows a detailed view interface 300B of the first available scheduled request 310A. The detailed view interface 300B of the available scheduled request may provide additional details including a nearby pickup location 313A (also referred to as a request location) and may display the information enlarged in a larger screen such that the provider may more easily determine the request location and destination location of the scheduled request. Accordingly, the provider may more easily determine whether they would like to claim the available scheduled request. A “back” interactive element 304 may also be presented to allow the provider to return to the available scheduled requests interface 300A.

FIG. 3C shows claimed scheduled requests that have been added by a provider through a claimed scheduled request interface 300C. The claimed scheduled request interface 300C may be accessed through a provider application operating on a provider computing device 350 of a provider. The claimed scheduled request interface 300C may include one or more claimed scheduled requests 310A that have been added by the provider and are associated with the provider. The claimed scheduled request interface 300C may display similar scheduled request information to the provider as the available scheduled request interfaces 300A-300B including a day indicator 308, a time indicator 311A, a pickup location 314A, and an estimated fare value 315A for the request. However, the request location may now show the exact address to allow the provider to plan ahead for the scheduled request. Any number of claimed scheduled requests may be presented through the interface 300C. An indicator 307 showing the number of claimed scheduled requests may also be displayed. Additionally, conditions 330A for being matched with the claimed request may also be displayed to the provider. For example, the provider may need to be online and accepting requests at a particular time and/or may need to be within a distance of the request location such that they can meet an estimated arrival time (ETA) for the scheduled request. The route may be presented in a map interface such that the provider may easily identify where in the region or area the request location and destination location for the claimed scheduled request. Accordingly, the provider may quickly, easily, and intuitively review one or more claimed scheduled requests that they have claimed through the interfaces.

Additionally, the claimed scheduled request indicator 310A may also be interactive such that if the provider may select the claimed scheduled request information by selecting the interactive map element 310A, additional details may be provided for further review of the presented map and/or claimed request details. Accordingly, FIG. 3D shows a detailed view interface 300D of the scheduled requests 310A they have claimed. The detailed view interface 300D may provide additional details including a route 312A, pickup location 313A (also referred to as a request location), destination location 314A, etc., and may display the information enlarged in a larger screen such that the provider may more easily determine the request location and destination location of the scheduled request. Further, a “remove from scheduled rides” button or interactive element may be presented to allow the provider to decline the claimed scheduled request. Accordingly, once a scheduled request is claimed, the provider may also remove their claim which will move the scheduled request back into the available scheduled request pool. A “back” interactive element 304 may also be presented to allow the provider to return to the claimed scheduled request interface 300C.

FIG. 4 illustrates an example block diagram 400 of a ride matching system 130, in accordance with an embodiment of the present techniques. As described above, the ride matching system 130 may identify and facilitate scheduled request matching from requestors 110 associated with requestor computing devices 120 with available providers 140 associated with provider computing devices 150. The ride matching system 130 may include a requestor interface 131, a provider interface 132, and a ride matching module 133 including a scheduling module 134, and a real time matching module 135. The ride matching system 130 may also include a requestor information data store 136A, a provider information data store 136B, a scheduled match feed 136C, a historical ride data store 136D, and a navigation data store 136E, and a real-time match feed 136F which may be used by any of the modules of the ride matching system 130 to obtain information in order to perform the functionality of the corresponding module. The real-time match feed 136F may include request information related to current pending requests that the ride matching system is attempting to be matched with available providers in an area. The ride matching system 130 may be configured to communicate with a plurality of requestor computing devices 120 and a plurality of provider computing devices 150. Although the ride matching system 130 is shown in a single system, the ride matching system 130 may be hosted on multiple server computers and/or distributed across multiple systems. Additionally, the modules may be performed by any number of different computers and/or systems. Thus, the modules may be separated into multiple services and/or over multiple different systems to perform the functionality described herein.

Although embodiments may be described in reference to ride requests, any number of different services may be provided through similar request and matching functionality. Accordingly, embodiments are not limited to the matching of ride requests and one of ordinary skill would recognize that embodiments could be implemented for any number of different services that have requestors and providers being matched through a network of connected computing devices.

The requestor interface 131 may include any software and/or hardware components configured to send and receive communications and/or other information between the ride matching system 130 and a plurality of requestor computing devices 120. The requestor interface 131 may be configured to facilitate communication between the ride matching system 130 and the requestor application 121 operating on each of a plurality of requestor computing devices 120. The requestor interface 131 may be configured to periodically receive ride requests, location information, a request location (also referred to as a “pick-up” location), requestor status information, a location of the requestor computing device, progress toward a request location by the requestor computing device, and/or any other relevant information from the requestor computing device 120 when the requestor application 121 is active on the requestor computing device 120. The ride request may include a requestor identifier, location information for the requestor computing device 120, a pick-up location for the ride request, one or more destination locations, a pick-up time, and/or any other suitable information associated with providing a service to a requestor. The ride request may be sent in a single message or may include a series of messages. The ride matching module 133 may receive the ride request and update a historical ride data store 136D with the ride request information.

Additionally, the requestor interface 131 may be configured to send ride match messages, location information for the provider computing device, provider information, travel routes, pick-up estimates, traffic information, requestor updates/notifications, and/or any other relevant information to the requestor application 121 of the requestor computing device 120. The requestor interface 131 may update a requestor information data store 136A with requestor information received and/or sent to the requestor, a status of the requestor, a requestor computing device location, and/or any other relevant information.

A requestor computing device 120 may include any device that is configured to communicate with a ride matching system 130 and/or provider computing device 150 over one or more communication networks 170. The requestor computing device 120 may comprise a processor, a computer-readable memory, and communication hardware and/or software to allow the requestor computing device 120 to communicate over one or more communication networks 170. For example, a requestor computing device 120 may include a mobile phone, a tablet, a smart watch, a laptop computer, a desktop computer, and/or any other suitable device having a processor, memory, and communication hardware. In some embodiments, the requestor computing device 120 may include a requestor application 121 that is configured to manage communications with the ride matching system 130 and interface with the user (i.e., requestor) of the requestor computing device 120. The requestor application 121 may allow a user to request a ride, monitor the status of a matched ride, pay for a ride, monitor past rides, perform any other requestor-oriented services related to the ride matching system 130, and/or obtain any other requestor-oriented information from the ride matching system 130.

The provider interface 132 may include any software and/or hardware configured to send and receive communications and/or other information between the ride matching system 130 and a plurality of provider computing devices 150. The provider interface 132 may be configured to periodically receive location information of the provider computing device 150, provider status information, and/or any other relevant information from the provider computing device 150 when the provider application 151 is active on the provider computing device 150. Additionally, the provider interface 132 may be configured to send ride requests, location information of a requestor computing device 120, pick-up locations, travel routes, pick-up estimates, traffic information, provider updates/notifications, and/or any other relevant information to the provider application 151 of the provider computing device 150. The provider interface 132 may update a provider information data store 136B with provider information received and/or sent to the provider, a status of the provider, a provider computing device location, and/or any other relevant information.

A provider computing device 150 may include any computing device that is configured to communicate with a ride matching system 130 and/or provider computing device 150 over one or more communication networks 170. The provider computing device 150 may comprise a processor, a computer-readable memory, and communication hardware and/or software to allow the provider computing device 150 to communicate over one or more communication networks 170. For example, a provider computing device 150 may include a mobile phone, a tablet, a smart watch, a laptop computer, a desktop computer, and/or any other suitable device having a processor, memory, and communication hardware. In some embodiments, the provider computing device 150 may include a provider application 151 that is configured to manage communications with the ride matching system 130 and interface with the user of the provider computing device 150. The provider application 151 may allow a user to accept a ride request, review available and claimed scheduled rides through the interfaces described above in reference to FIGS. 3A-3D, monitor the status of a matched ride, obtain or generate navigation directions or a mapped route for a matched ride, get paid for a ride, monitor past rides, perform any other provider-oriented services related to the ride matching system 130, and/or obtain any other provider-oriented information from the ride matching system 130.

The ride matching module 133 may include a software module that is configured to process ride requests, ride responses, and other communications between requestors and providers of the ride matching system 130 to match a requestor and a provider for a requested service. For example, the ride matching module 133 may be configured to identify available providers for a ride request from a requestor by identifying a geographic region associated with the pick-up location and may search a provider information data store 136B to identify available providers within a predetermined distance of the pick-up location and/or the geographic region. Additionally, in embodiments, the ride matching module 133 may be configured to coordinate scheduled requests and provide available scheduled requests to be reviewed for a provider as will be described in further detail below in reference to the scheduling module 134.

The ride matching module 133 may include a scheduling module 134 and a real time matching module 135 that are configured to allow the ride matching module 133 to provide the scheduling interfaces and functionality described herein. For example, when the ride matching module 133 receives a scheduled request, the ride matching module may pass the request information including the request location, the request time, the requestor identifier, the location of the requestor, and/or any other relevant information to the scheduling module 134.

The scheduling module 134 may be configured to filter scheduled requests between those that may be available for claiming by providers and those that may be matched using real-time match processing of available providers at the indicated time for a scheduled service to be provided. For example, the scheduling module 134 may be configured to determine whether the request location associated with a scheduled ride is in a region that has low success and/or insufficient data to determine whether a scheduled request may be successfully matched for the request time and/or request location. As such, the scheduling module 134 may be configured to determine whether the scheduled request is eligible for pre-arranged claiming by a provider before the time to provide a service based on at least one of the request location and the request time of the scheduled request. In some embodiments, the eligibility determination process may include determining a number of matches associated with an area surrounding the request location over a period of time and comparing the number of matches to a match threshold. The threshold may indicate whether the number of matches for the area and time are sufficient over a period of time (e.g., 1 month, 3 months, 1 week, 1 year, etc.) to know that the ride matching system 130 has sufficient ride history in that area to determine whether a scheduled ride may be successfully matched for the time and location. For example, a threshold number of matches may include 10, 50, 100, 200, or 500 matches over a time period in a surrounding area associated with request location. The threshold number of matches may be divided into different time periods as the match statistics and number of requests may fluctuate during different times of the day.

In some embodiments, the eligible location determination process may include determining a successful request match ratio associated with an area surrounding the request location over a period of time and comparing the successful request match ratio to a successful request match threshold. Accordingly, those areas that tend to have inconsistent available providers may have a matching percentage that is below a threshold value (e.g., 50%, 70%, etc.). Accordingly, the ride matching system may determine whether the request location and request time have a successful history of matches for that region and time to indicate that a request may be successfully matched. The scheduling module 134 may update a scheduled ride feed 136C with those scheduled requests that indicate that the request may not be successfully matched for the time and location. If the scheduled request is not eligible because the request will likely be successfully matched for the request time and location, the scheduling module 134 may update the real-time ride feed 136F with the scheduled request information with an indication of the time that the scheduled ride should be triggered for real-time matching.

The scheduling module 134 may use any other suitable methods for determining whether a request location and request time has a high chance of being successfully matched or if the scheduled ride should be included in a scheduled ride feed to be presented to providers for claiming. For example, in some embodiments, the scheduling module 134 may perform available provider prediction by obtaining an available provider rate associated with the request location from a historical ride data store 136D that may indicate the historical rate of available providers coming online near the request location. For example, some areas may have a high rate of providers coming online during particular times that the ride matching system may use to predict available providers near the request location. Accordingly, by tracking and monitoring system activity as well as tracking estimated arrival times for providers and requestors over time, the scheduling module 134 can more efficiently and effectively determine whether successful matching rates for a scheduled request indicate that the scheduled ride should be eligible for claimed ride functionality.

The scheduling module 134 may further be configured to determine one or more candidate providers associated with the scheduled request to provide as an available scheduled request for claiming. The scheduling module 134 may determine one or more candidate providers for the scheduled request through any suitable method. For example, the scheduling module 134 may use a residential address, historically claimed request locations, historically claimed request times, previously matched request locations, previously matched request times, and/or any other relevant information for determining relevant providers to a scheduled request. In some embodiments, a relevance score may be generated for the scheduled request to a set of providers based on provider profile, driving history, and/or any other relevant information to identify relevant providers for a scheduled request.

Further, the scheduling module 134 may determine a scheduled request feed for each of the set of candidate providers and add an available scheduled ride to a scheduled request feed for a set of providers that are determined to be relevant to the scheduled ride. For each of the provider's scheduled request feed, the scheduling module 134 may filter presented available scheduled requests based on conflicts between available scheduled rides. For example, multiple relevant available scheduled requests may be have overlapping times and/or locations that may create a conflict such that only one of the overlapping scheduled requests could be completed by the candidate provider. Accordingly, the scheduling module 134 may rank the available scheduled rides within the scheduled request feed for each provider to ensure that conflicts are not presented to the provider. The scheduling module 134 may rank the scheduled requests according to request value to the candidate provider. The request value may be based on an estimated amount of payment for providing the scheduled request and a travel distance to the request location such that driver downtime is built into the value calculation.

The scheduling module 134 may be configured to update a scheduled ride feed associated with the candidate provider to include the ranking of scheduled requests. Accordingly, when the provider checks their available scheduled rides, the scheduled ride may be displayed according to value and may be filtered to ensure no conflicting requests are displayed. Accordingly, the scheduling module 134 may send the scheduled request to a provider computing device associated with one or more candidate providers and the scheduled requests may be configured to be presented through a scheduled ride interface configured to allow the candidate provider to review and approve the scheduled request prior to the request time associated with the scheduled request as described above in reference to FIGS. 3A-3D. The scheduled ride feed 136C may be updated to include the provider information associated with each available scheduled request and if a provider claims the scheduled ride, the scheduled ride may be associated with a provider and the scheduled ride feed may be updated to indicate the association.

If the scheduling module 134 determines that a provider has accepted the scheduled request through the scheduled ride interface, the scheduling module 134 may be configured to associate the candidate provider with the scheduled request by indicating that the candidate provider has claimed the scheduled request. When a request time approaches for an associated scheduled ride to a provider, the scheduling module 134 may be configured to evaluate whether the claimed provider is going to meet the scheduled request and if so, may send matching information to the provider computing device upon triggering of a dispatch time for the scheduled request.

The scheduling module 134 may evaluate whether a claimed provider is going to successfully complete the scheduled request by determining a match window time for the scheduled request, determining an estimated arrival time of the provider to the request location based on a status of the provider computing device and a location of the provider computing device at the match window time, and comparing the estimated arrival times. The match window time may be determined based on an average match time for a request in an area associated with the request location. Accordingly, those areas with fewer successful matches may likely have higher matching times as well.

If the scheduling module 134 determines that the estimated arrival time of the provider is later than the request time of the scheduled request, the scheduling module 134 may attempt to match one of a set of available providers to the scheduled request. The scheduling module 134 may pass the request to the real time matching module 135 to determine a set of available providers having earlier estimated arrival times to the request location than the provider.

In some embodiments the real-time matching module may determine a match window (i.e., the time in which the scheduled request should be matched for the request location and time). The match window may be tracked and stored for each general region (also referred to as a “geo-hash”) and the request may be stored with the match window such that the real time matching module knows when to attempt to match the scheduled request in order to ensure the request time is met.

The real time matching module 135 may identify available providers in the geographic area around the request location and use those providers to attempt to match a request. In some embodiments, the real time matching module 135 may use a threshold distance (e.g., 10 miles, 15 miles, etc.), one or more zip codes or other geographic identifiers (e.g., streets, blocks, neighborhoods, city, region, etc.), or any other suitable geographic limitation to identify available providers relevant to a request location. For example, the travel time estimation module 134 may search the provider information data store 136B to identify any available providers that are located within a certain distance from the request location. The travel time estimation module 134 may also limit the search for available providers to those that meet ride request criteria such that the available provider can serve the request. For example, whether a provider vehicle is a sedan, luxury, SUV, or other type of car, has a particular type of feature or amenity (e.g., car seat, dog friendly, etc.), has a number of available seats (e.g., request for 2 people, etc.), and/or may use any other stored information at the ride matching system to limit available providers to those that can serve the request.

Once the travel time estimation module 134 identifies the available providers in the area, the travel time estimation module 134 may calculate an estimated travel time for each of the providers from their current location to the request location. As discussed above, the travel time estimation module 134 may incorporate traffic, weather, road closures, and/or any other conditions that may affect travel time into the estimation. The travel time estimation module 134 may use historical ride data that is relevant for the time of day, streets and geographic region, as well as stored previous rides over those times, areas, road conditions, and/or any other information to obtain an estimate for the provider to travel from their current location to the request location. For example, the travel time estimation module 134 may be configured to obtain the location of each of the provider computing devices. The travel time estimation module 134 may be configured to identify the request location and map navigation routes for each of the providers and the requestor to the request location. The travel time estimation module 134 may calculate an estimated time of arrival for a variety of different routes based on navigation information obtained from a navigation data store 136E. The navigation information may include real-time and historical traffic information, historical travel time information, known routes for a geographic area or region, traffic rules, and/or any other suitable information for mapping and/or identifying potential routes for traveling from one location to another based on a type of transportation (e.g., driving, biking, sailing, flying, etc.). The travel time estimation module 134 may map a plurality of possible routes from the provider location to the request location and generate an estimated arrival time for each of the potential mapped routes. The travel time estimation module 134 may select the fastest route and/or the most probable route for each of the providers and the corresponding estimated travel time for that route as the estimated travel time for the provider. The travel time estimation module 134 may incorporate current traffic conditions, road closures, weather conditions, and any other relevant travel time related information to calculate an estimated arrival time for the provider. The estimated arrival time may also be calculated by taking an average of the arrival time of each of the mapped routes, selecting the estimated arrival time for the fastest route, receiving a selection of one of the potential routes by the provider, identifying the route being taken based on the route being used by the provider, and/or through any other suitable method. If the provider makes a wrong turn and/or follows a different route than that calculated by the travel time estimation module 134, the travel time estimation module 134 may obtain the updated location of the provider computing device and recalculate the possible routes and estimated arrival times. As such, the estimated travel times may be updated as travel and road conditions, weather, etc. are updated. Accordingly, the travel time estimation module 134 may determine a navigation route associated with the request location and an estimated travel time for each of the providers. Further, the estimated time may be determined through any suitable method including taking an average of multiple routes, selecting the fastest route, adding additional cushion time when certainty is low for the estimate of the time, etc. Accordingly, the travel time estimation module 134 may determine an estimated travel time for each of the available providers in the area that may potentially match the request.

Additionally, the travel time estimation module 134 may determine an arrival time for the requestor. The arrival time for the requestor may be dependent on a travel time as well as a request time that may have been provided in the request. For example, the travel time may be determined by determining an estimated travel time from the current location of the requestor to the request location. The travel time may be estimated by searching the requestor information data store 136A for previous time estimates associated with the route and/or the historical ride data store 136D for relevant travel times associated with the route. The requestor travel time may be determined based on walking speed and may use the navigation data store 136E to identify the travel time associated with walking from different locations. Additionally, where the requestor is located in a building, the travel time estimate may incorporate average travel times for requestors in those buildings to leave the building in order to improve the accuracy of the time estimate. Additionally, the requestor arrival time may have a request time component that is dictated by a delay input by the user into the application upon requesting the ride. For example, the requestor may need another 10 minutes before they are ready to leave but may request the ride so that they know they will be matched with a provider upon being ready to leave. Accordingly, the requestor may request that the ride be scheduled for 10 minutes, an hour, a day, or any other relevant time in the future. Accordingly, the arrival time may have both a travel time and a request time component.

Additionally, in some embodiments, the travel time estimation module 134 may obtain all the travel estimates for the providers and the requestor by requesting estimates from a third party mapping service. For example, the travel time estimation module 134 may call an API associated with the third party mapping service such that a request location, current location of the requestor, current locations of the providers, and the request time are provided to the third party mapping service. The mapping service may perform the actual estimation of the routes and return the estimates to the travel time estimation module 134 for use in selecting a provider for the match. Either way, the travel time estimation module 134 may return the travel time estimates for the available providers and the requestor to the ride matching module 133 for further match processing.

The ride matching module 133 may then provide the estimated travel times for the providers and the requestor to the provider selection module 135. The provider selection module 135 may obtain the estimated travel times and may select one or more providers that should be matched with the request. The provider selection module 135 may select a subset of the available providers and select one of the providers based on system efficiency, rankings, route, arrival time, and/or any other suitable information that can be used for matching. For example, two available providers may be identified as eligible for a request where one of the providers is traveling away from the request location while the other is traveling toward the request location. The provider selection module 135 may select the provider that is traveling toward the request location because it causes less driving, fewer turns, safer driving, and all the other benefits of allowing providers to maintain their current direction of travel.

The real time matching module may determine the provider has the earliest estimated arrival time of a set of remaining available providers and match the provider for the scheduled request. However, the real time matching module may perform the typical matching process to determine whether other providers may be a better match for the request.

The ride matching module 133 may provide the ride request to the provider interface 132 with the provider contact information or provider identifier so that the ride request may be sent to one or more available providers. The ride matching module 133 may send the ride request and/or the information from the ride request to one or more of the selected available providers to determine whether the available providers are interested in accepting the ride request. The one or more available providers may receive the ride request through the provider application 151 of the provider computing device 150, may evaluate the request, and may accept or deny the request by providing an input through the provider application 151. A ride response message may be sent to the ride matching system 130 indicating whether a ride was accepted and including a provider identifier, a location of the provider, and/or any other suitable information to allow the ride matching system 130 to process the response. Alternatively, the provider may ignore the request and after a predetermined period of time, the request may be considered denied and a corresponding ride response message may be sent to the ride matching system 130. In some embodiments, no response may be sent unless a ride request is accepted and the ride will be assumed to be denied unless a response is received from the provider. In other embodiments, no response is necessary and the ride may be immediately accepted. An indicator, flag, and/or other information may be passed back to the ride matching system to assure the system that the provider computing device received the request.

The ride matching module 133 may receive the ride response, evaluate whether the provider accepted or declined the request, and may either find additional available providers for the request (if declined) or determine the ride request has been accepted and send matched ride information to the requestor computing device 120 and the provider computing device 150. The matched ride information may include provider information, requestor information, the pick-up location, the current location of the provider computing device, the current location of the requestor computing device, an estimated time of arrival for the provider, and/or any other suitable information to allow the requestor and the provider to complete the requested service. The ride matching module 133 may update the historical ride data store 136D with the corresponding matched ride information for the matched ride. Accordingly, the ride matching module may perform more efficient and effective matching of requests with providers.

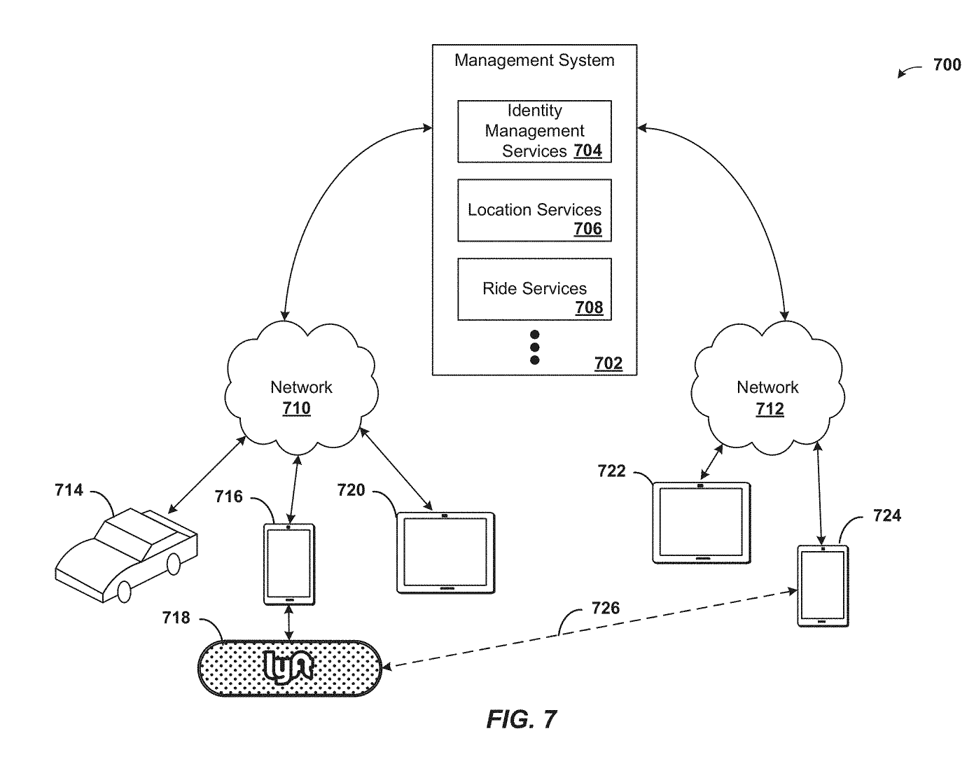

In addition, in some embodiments the provider computing device 150 is part of an autonomous vehicle system. Indeed, as described in further detail below with reference to FIG. 7, the ride matching system 130 can communicate with an autonomous vehicle to match ride requests received from a requestor computing device 120 with a provider computing device 150 associated with the autonomous vehicle. To illustrate, an autonomous vehicle can pre-accept a scheduled ride request. As an example, the ride matching system 130 can communicate with the autonomous vehicle to provide an indication that a requestor computing device 120 has submitted a scheduled ride request. In addition, in some embodiments the autonomous vehicle can accept a scheduled ride request in anticipation of the scheduled time for the scheduled ride request. Indeed, the autonomous vehicle can accept a scheduled ride request based on one or more factors such as a pick-up time of the scheduled request, location and/or availability of the autonomous vehicle, value, ETA, pick-up location, etc.

In addition, the autonomous vehicle can automatically (e.g., without user input) accept a scheduled ride request. In some embodiments, the autonomous vehicle accepts a ride request before the ride matching system 130 provides any notifications of the ride request to provider computing devices associated with other providers (e.g., human drivers).

For example, the autonomous vehicle can accept ride requests that have a pick-up location that is within a threshold distance of the location of the vehicle. As another example, the autonomous vehicle can accept a ride request that has an ETA within a threshold time period. As still another example, the autonomous vehicle can accept a ride request that has a predicted value (e.g., ride fare earned) that satisfies a value threshold. In any event, the autonomous vehicle can accept ride requests and navigate to a pick-up location without user input or direction from a driver or administrator.

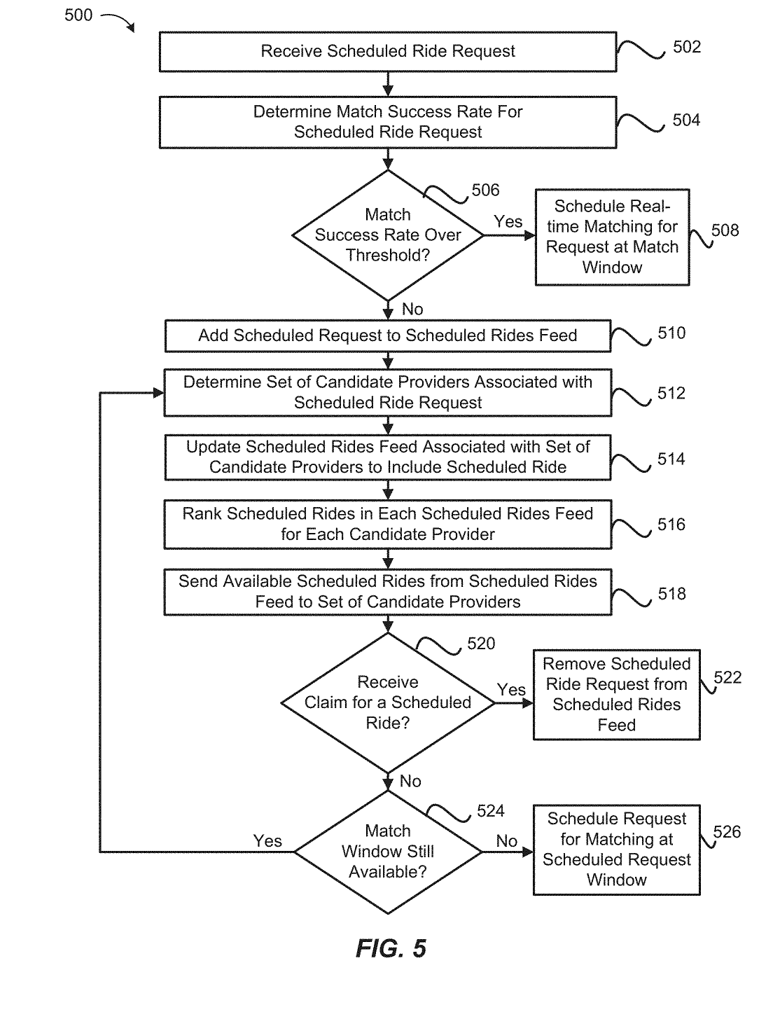

FIG. 5 illustrates an exemplary flow diagram of a method for filtering scheduled ride requests to one of a plurality of request feeds, in accordance with embodiments of the present techniques. At step 502, the ride matching system receives a scheduled ride request from a requestor computing device. The scheduled ride request may include a request location (i.e., pick-up location) for the ride request, a request time, a requestor identifier, a requestor computing device location, and/or any other relevant information associated with the ride request and/or requestor.

At step 504, the ride matching system may determine a match success rate for the scheduled ride request. The match success rate may be dependent on the request location and the request time for the scheduled ride. The ride matching system may determine the match success rate for the request location and the request time through any suitable manner. For example, the ride matching system may request historical matching rates for an area surrounding the request location. The area may correspond to one or more geographic regions associated with the request location. For example, the location may be associated with a geographic hash (“geo-hash”) that identifies a segmented area of a region associated with the request location. The geo-hash may be associated with any suitable area including a zip code, neighborhoods, blocks, cities, counties, and/or any other suitable division of a geographic region. The scheduled request time may be associated with time ranges, times of day (e.g., early morning, morning, early afternoon, afternoon, etc.), behavior (e.g., commute times, after-hours, etc.), and/or any other suitable groupings of times associated with a request. The ride matching system may search a historical ride datastore 136D associated with the geographic area and a time span to identify match success rates for a location and time associated with the scheduled request.

At step 506, the ride matching system may compare the determined match success rate for the scheduled request to a threshold match success rate. Further, if there are insufficient number of matched rides for a region and/or time of a scheduled request, the ride matching system may determine that the threshold is not met and/or may determine that the threshold is not met for the scheduled request.

At step 508, if the match success rate of the scheduled request is over a threshold, thus indicating that there is a good chance that a request issued at the scheduled request time may be matched with a provider, the ride matching system may schedule a real-time matching for the request at the scheduled time. For example, the ride matching system may determine a match window associated with the location and time of the scheduled request that indicates the average amount of time it takes for a request to be accepted and a provider to arrive at a request location for a request at the time and location of the scheduled request. Accordingly, the ride matching system may determine when a real-time request should be issued to ensure that a provider arrives at the request location on time for the scheduled request.

At step 510, if the match success rate of the scheduled request is under a threshold and/or it is otherwise indicated that there is a good chance that a request issued at the scheduled request time will not be successfully matched with a provider, the ride matching system may add the scheduled request to a scheduled rides feed data store 136C to allow the scheduled request to be reviewed and claimed by one or more providers.

At step 512, the ride matching system may determine a set of candidate providers associated with the scheduled request in order to target the scheduled ride to one or more candidate providers to review and claim one of the scheduled requests. In some embodiments, the scheduled requests within the scheduled rides feed may be segmented and targeted to particular candidate providers that are associated with at least one of the request location and/or request time of the scheduled request.

At step 514, the ride matching system may update the scheduled rides feed associated with each of a set of candidate providers to include the scheduled rides. As such, when the associated set of candidate providers open the scheduled rides review and claiming interfaces, the schedule ride may be presented for review and claiming. The scheduled rides within the scheduled ride feed may be associated with multiple candidate providers such that the scheduled rides may be presented through the interfaces described herein for review by the one or more candidate providers.

At step 516, the ride matching system may rank the scheduled rides within each candidate provider scheduled rides feed to identify the most valuable available scheduled rides for each of the candidate providers. Accordingly, available rides may be ranked according to value and conflicting available scheduled rides may be filtered such that only non-conflicting available rides are presented through the interface to each provider. Further, the value of each available scheduled ride may be different for different providers as the value is a function of the location of the provider and/or how the request fits into their routine, travel to and from their home address, typical matched rides, hours, etc. Thus, relevance scores and/or rankings of different scheduled rides may be different for two providers that are both provided with the same scheduled ride in their respective scheduled ride feed.

At step 518, the ride matching system may send available scheduled rides from each of the scheduled rides feed to the set of candidate providers for review. The available scheduled rides may be presented through available scheduled request interfaces 300A-300B and claimed scheduled request interfaces 300C-300D as described in reference to FIGS. 3A-3D. Accordingly, the candidate providers may review the ranked available scheduled rides and may claim one or more available scheduled rides.

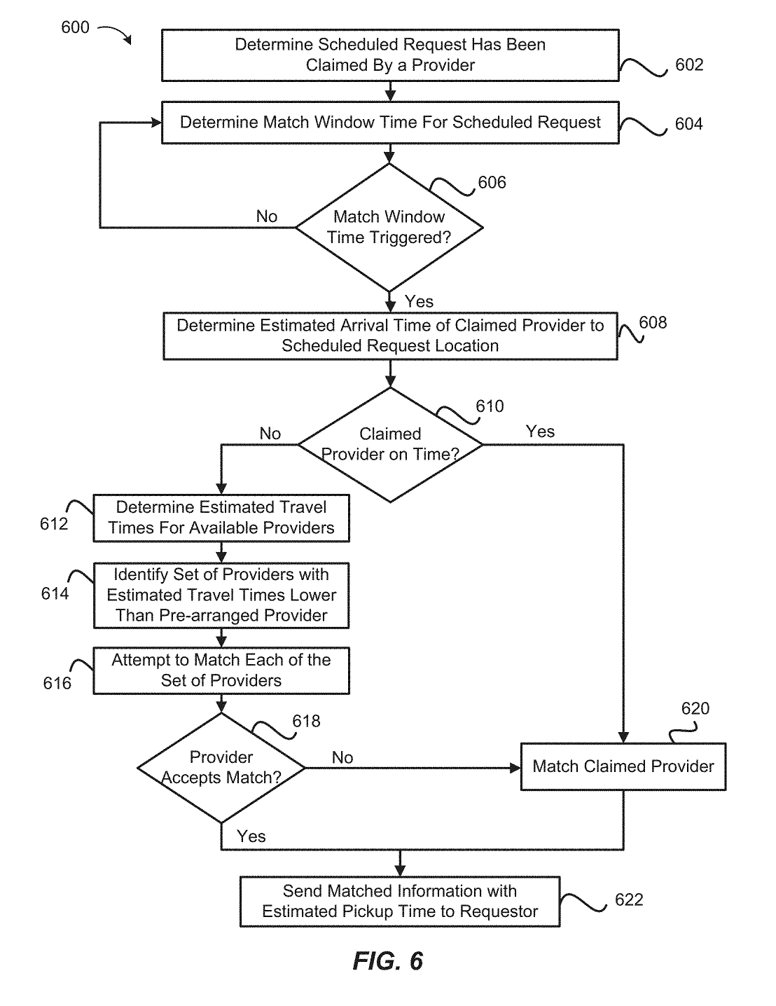

At step 520, the ride matching system may determine that one of the candidate providers has claimed one of the available scheduled rides. At step 522, if a claim input is received from a scheduled ride, the ride matching system may remove the scheduled ride request form the scheduled rides feed 136C and may associate the scheduled ride with the provider that claimed the scheduled request. The operation of dispatching and/or initiating the match as the request time approaches is discussed in further detail below in reference to FIG. 6.

At step 524, if no claim is received for a scheduled ride, the ride matching system may determine whether a match window is still available for each of the available scheduled rides in the scheduled ride feed. As described herein, the match window may be determined based on the average amount of time to match a provider and have the provider arrive at a request location in the area. As such, the match window provides a time before the request time in which a real-time matching request may be issued for the request and a provider may be able to be matched. Further, based on areas with a lack of match history and/or where it is not clear what the match window may be, a default match window may be used (e.g., 30 minutes, 45 minutes, 1 hour, etc.). If the match window is still open (i.e., there is more than the match window amount of time before the scheduled request time), the ride matching system may repeat steps 512-524 to determine a set of providers that may be relevant to the available scheduled rides to determine whether a provider is interested in claiming an available scheduled ride.

At step 526, if the match window is no longer available, the ride matching system may schedule the request for real-time matching at the scheduled request window. As such, no provider claimed the scheduled request and the traditional matching process may be initiated for the request to determine whether a provider is available and willing to accept the request. For example, if the match window is 30 minutes for the request time and request location, the scheduled ride may be closed from the scheduled ride feed interfaces described herein 30 minutes before the scheduled request time and an on-demand real time matching process may be initiated to attempt to match an available provider within the average 30 minute time period for matching a provider with a similar request.

FIG. 6 illustrates an exemplary flow diagram 600 of a method for matching a scheduled ride request as a request time approaches, in accordance with embodiments of the present techniques. At step 602, the ride matching system determines that a scheduled request has been claimed by a provider and is associated with that provider. Any of the suitable processes for determining that an available scheduled request has been claimed by a provider as described herein may be used to allow a provider to claim a scheduled request.

At step 604, the ride matching system determines a match window time for the scheduled request. As described above, the match window is based on the request location and request time and may be obtained from a historical ride data store 136D and/or through any other suitable process.

At step 606, the ride matching system determines whether the match window time has triggered, thus initiating the ride matching process. If the match window time has not triggered, the ride matching system may repeat step 604 and wait until the match window time has been triggered. For example, the matching window for a scheduled request may be 20 minutes and the match window time may trigger when the time becomes 20 minutes before the scheduled request time.

At step 608, if the match window time has triggered, the ride matching system determines an estimated arrival time for a claimed provider to the scheduled request location. For example, the ride matching system may determine an ETA from the current location of the claimed provider to the request location. In some embodiments, this step may also include determining whether the provider is online and accepting requests. If not, notifications and reminders may be issued to the provider in order to remind the provider that they have claimed the request. The ride matching system may determine ETA incorporating current requests that have been accepted and/or are in progress by the provider and where the provider may be located upon drop-off of the current accepted request. Accordingly, the ride matching system may use predictive location and travel times associated with those locations to determine whether the provider may successfully arrive at the scheduled request time. Further, the ride matching system may limit new requests that are sent to the provider when the match window approaches such that only requests that may fit into the claimed scheduled ride pickup time and place may be sent to the provider as the scheduled time approaches.

At step 610, the ride matching system determines whether the claimed provider is going to be on-time for the scheduled pickup time and location based on the determined ETA to the request location. The determination as to whether a provider may be on-time may include a range of times such that the provider may only be determined to not be on-time when the request is outside a threshold value over the request time (e.g., 5 minutes) or may be strictly enforced on request time. Accordingly, the ride matching system may compare the ETA with the scheduled time to determine whether the provider may arrive on schedule for the scheduled request.

At step 612, the ride matching system determines that the provider may not arrive at the request location at the schedule time or within a predefined threshold time within the scheduled request time. Accordingly, the ride matching system may determine estimated travel times for providers within a geographic region proximate to the request location. As described above, the estimated travel times may be determined through any suitable process including mapping all possible routes to the request location and selecting the route with the fastest route to the request location, taking an average of the times of multiple routes, and/or through any other suitable method. Additionally, a third party mapping service may be used to identify estimated travel times for each of the available providers near the request location. Accordingly, the ride matching system may attempt to match other providers with the scheduled request to determine if another provider may be found that will meet the scheduled request time.

At step 614, the ride matching system may use the estimated travel times to identify available providers that may make it to the scheduled request time and location before the claimed provider. Accordingly, the ride matching system may identify providers with estimated arrival times that are closer to the scheduled time than the claimed provider.

At step 616, the ride matching system may attempt to match each of the identified set of providers that may arrive at the scheduled time before the claimed provider. Accordingly, the real-time match processing may be performed where a transportation request may be transmitted to a provider computing device associated with each of the providers in order of best match or relevance to the scheduled request. The best provider match may be made using any suitable criteria including rating, existing travel route, and/or any other suitable information. Each of the providers may have a period of time to review and either accept or decline the transportation request.

At step 618, the ride matching system may determine whether one of the set of providers accepts the transportation matching request. This process may be repeated for each of the set or providers that have an earlier estimated arrival time to the request location than the claimed provider.

At step 620, if none of the set of providers accepts the transportation request and/or if the claimed provider is on time to complete the scheduled request, the ride matching system may match the claimed provider with the scheduled request. The ride request may include the request location, requestor information, and/or any other relevant information to allow the provider to identify whether they want to accept or decline the ride request. The provider may review the ride request, accept the request, and send a ride response including an indicator that the provider accepts the ride request. The provider computing device may receive or generate a navigation route to the request location and may start to travel toward the request location.

In some embodiments, the ride matching system may determine whether matching the request with the claimed provider increases the system efficiency or if the ride matching system should wait for the request time to get closer to minimize provider downtime, thus making more eligible provider matches available. As such, in some embodiments, the ride matching system may filter the request location and destination locations of requests that may be matched with the claimed provider in order to keep them providing services in an area before the time to match the claimed provider to the request is due. Accordingly, additional requests may be submitted to the claimed provider as long as they will not affect the ability for the provider to be on-time for the scheduled request.

Further, in some embodiments, the ride matching system may also wait for additional eligible providers to become available due to drop-offs from pre-existing matched rides or the appearance of new drivers in the area before matching the claimed provider. Accordingly, the ride matching system may determine the predicted provider availability for the request based on the provider arrival time and determine whether a late arrival match with the provider should be made or if the system should wait for additional available providers to become eligible.

At step 622, the ride matching system sends matched information to the requestor computing device to inform the request that a match has occurred and provide provider ETA and provider information associated to the requestor.

Note that although the present example focuses on on-demand ride-sharing applications, any suitable service may be performed using similar functionality. For example, delivery of services may have a similar process implemented to find the location of delivery of the service.

FIG. 7 shows a requestor/provider management environment 700, in accordance with various embodiments. As shown in FIG. 7, a management system 702 can be configured to provide various services to requestor and provider devices. Management system 702 can run one or more services or software applications, including identity management services 704, location services 706, ride services 708, or other services. Although three services are shown as being provided by management system 702, more or fewer services may be provided in various implementations. In various embodiments, management system 702 may include one or more general purpose computers, server computers, clustered computing systems, cloud-based computing systems, or any other computing systems or arrangements of computing systems. Management system 702 may be configured to run any or all of the services and/or software applications described with respect to various embodiments of the present techniques described herein. In some embodiments, management system 702 can run any appropriate operating system as well as various server applications, such as common gateway interface (CGI) servers, JAVA® servers, hypertext transport protocol (HTTP) servers, file transfer protocol (FTP) servers, database servers, etc.

Identity management services 704 may include various identity services, such as access management and authorization services for requestors and providers when interacting with management system 702. This may include, e.g., authenticating the identity of providers and determining that the providers are authorized to provide services through management system 702. Similarly, requestors' identities may be authenticated to determine whether the requestor is authorized to receive the requested services through management system 702. Identity management services 704 may also control access to provider and requestor data maintained by management system 702, such as driving and/or ride histories, personal data, or other user data. Location services 706 may include navigation and/or traffic management services and user interfaces, or other location services.

In various embodiments, ride services 708 may include ride matching and management services to connect a requestor to a provider. Ride services 708 may include a user interface and or may receive data from requestors and providers through applications executing on their respective devices. Ride services 708 may, e.g., confirm the identity of requestors and providers using identity management services 704, and determine that each user is authorized for the requested ride service. In some embodiments, ride services 708 can identify an appropriate provider using a location obtained from a requestor and location services 706 to identify, e.g., a closest provider. As such, ride services 708 can manage the distribution and allocation of provider and requestor resources, consistent with embodiments described herein.

Management system 702 can connect to various devices through network 710 and 712. Networks 710, 712 can include any network configured to send and/or receive data communications using various communication protocols, such as AppleTalk, transmission control protocol/Internet protocol (TCP/IP), Internet packet exchange (IPX), systems network architecture (SNA), etc. In some embodiments, networks 710, 712 can include local area networks (LAN), such as Ethernet, Token-Ring or other LANs. Networks 710, 712 can include a wide-area network and/or the Internet. In some embodiments, networks 710, 712 can include VPNs (virtual private networks), PSTNs (a public switched telephone networks), infra-red networks, or any wireless network, including networks implementing the IEEE 802.11 family of standards, Bluetooth®, Bluetooth® Low Energy, NFC and/or any other wireless protocol. In various embodiments, networks 710, 712 can include a mobile network, such as a mobile telephone network, cellular network, satellite network, or other mobile network. Networks 710, 712 may be the same as communication network 170 in FIG. 1. In some embodiments, networks 710, 712 may each include a combination of networks described herein or other networks as are known to one of ordinary skill in the art.

Users may then utilize one or more services provided by management system 702 using applications executing on provider and requestor devices. As shown in FIG. 7, provider computing devices 714, 716, 718, and/or 720 may include mobile devices (e.g., an iPhone®, an iPad®, mobile telephone, tablet computer, a personal digital assistant (PDA)), wearable devices (e.g., head mounted displays, etc.), thin client devices, gaming consoles, or other devices configured to communicate over one or more networks 710, 712. Each provider or requestor device can execute various operating systems (e.g., Android, iOS, etc.) and configured to communicate over the Internet, Blackberry® messenger, short message service (SMS), email, and various other messaging applications and/or communication protocols. The requestor and provider computing devices can include general purpose computers (e.g., personal computers, laptop computers, or other computing devices executing operating systems such as macOS®, Windows®, Linux®, various UNIX® or UNIX- or Linux-based operating systems, or other operating systems). In some embodiments, provider computing device 714 can include a vehicle-integrated computing device, such as a vehicle navigation system, or other computing device integrated with the vehicle itself.

Indeed, in some embodiments the provider computing device 714 is located on (e.g., integrated in) an autonomous vehicle. In particular embodiments, the autonomous vehicle may be an autonomous vehicle and equipped with an array of sensors, a navigation system, and a ride-service computing device. In particular embodiments, a fleet of autonomous vehicles may be managed by ride matching system 130. The fleet of autonomous vehicles, in whole or in part, may be owned by the entity associated with ride matching system 130, or they may be owned by a third-party entity relative to ride matching system 130. In either case, ride matching system 130 may control the operations of autonomous vehicles, including, e.g., dispatching select the autonomous vehicle to fulfill ride requests, instructing autonomous vehicles to perform select operations (e.g., head to a service center or charging/fueling station, pull over, stop immediately, self-diagnose, lock/unlock compartments, change music station, change temperature, and any other suitable operations), and instructing autonomous vehicles to enter select operation modes (e.g., operate normally, drive at a reduced speed, drive under the command of human operators, and any other suitable operational modes).

In particular embodiments, autonomous vehicles may receive data from and transmit data to ride matching system 130 and a third-party system. Example of received data may include, e.g., instructions, new software or software updates, maps, three-dimensional (3D) models, trained or untrained machine-learning models, location information (e.g., location of the ride requestor, the autonomous vehicle itself, other autonomous vehicles, and target destinations such as service centers), navigation information, traffic information, weather information, entertainment content (e.g., music, video, and news) ride requestor information, ride information, and any other suitable information. Examples of data transmitted from the autonomous vehicle may include, e.g., telemetry and sensor data, determinations/decisions based on such data, vehicle condition or state (e.g., battery/fuel level, tire and brake conditions, sensor condition, speed, odometer, etc.), location, navigation data, passenger inputs (e.g., through a user interface in the autonomous vehicle, passengers may send/receive data to ride matching system 130 and/or a third-party system), and any other suitable data.

In particular embodiments, autonomous vehicles may also communicate with each other as well as other traditional human-driven vehicles, including those managed and not managed by the ride matching system 130. For example, one the autonomous vehicle may communicate with another the autonomous vehicle data regarding their respective location, condition, status, sensor reading, and any other suitable information. In particular embodiments, vehicle-to-vehicle communication may take place over direct short-range wireless connection (e.g., WI-FI, Bluetooth, NFC) and/or over a network (e.g., the Internet or via ride matching system 130 or third-party system 870).

In particular embodiments, an autonomous vehicle may obtain and process sensor/telemetry data. Such data may be captured by any suitable sensors. For example, the autonomous vehicle may have a Light Detection and Ranging (LiDAR) sensor array of multiple LiDAR transceivers that are configured to rotate 360°, emitting pulsed laser light and measuring the reflected light from objects surrounding the vehicle. In particular embodiments, LiDAR transmitting signals may be steered by use of a gated light valve, which may be a MEMs device that directs a light beam using the principle of light diffraction. Such a device may not use a gimbaled mirror to steer light beams in 360° around the autonomous vehicle. Rather, the gated light valve may direct the light beam into one of several optical fibers, which may be arranged such that the light beam may be directed to many discrete positions around the autonomous vehicle. Thus, data may be captured in 360° around the autonomous vehicle, but no rotating parts may be necessary. A LiDAR is an effective sensor for measuring distances to targets, and as such may be used to generate a 3D model of the external environment of the autonomous vehicle. As an example and not by way of limitation, the 3D model may represent the external environment including objects such as other cars, curbs, debris, objects, and pedestrians up to a maximum range of the sensor arrangement (e.g., 50, 100, or 200 meters). As another example, the the autonomous vehicle may have optical cameras pointing in different directions. The cameras may be used for, e.g., recognizing roads, lane markings, street signs, traffic lights, police, other vehicles, and any other visible objects of interest. To enable the vehicle to “see” at night, infrared cameras may be installed. In particular embodiments, the vehicle may be equipped with stereo vision for, e.g., spotting hazards such as pedestrians or tree branches on the road. As another example, the autonomous vehicle may have radars for, e.g., detecting other vehicles and/or hazards afar. Furthermore, the vehicle may have ultra sound equipment for, e.g., parking and obstacle detection. In addition to sensors enabling the autonomous vehicle to detect, measure, and understand the external world around it, the autonomous vehicle may further be equipped with sensors for detecting and self-diagnosing its own state and condition. For example, the autonomous vehicle may have wheel sensors for, e.g., measuring velocity; global positioning system (GPS) for, e.g., determining the vehicle's current geolocation; and/or inertial measurement units, accelerometers, gyroscopes, and/or odometer systems for movement or motion detection. While the description of these sensors provides particular examples of utility, one of ordinary skill in the art would appreciate that the utilities of the sensors are not limited to those examples. Further, while an example of a utility may be described with respect to a particular type of sensor, it should be appreciated that the utility may be achieving using any combination of sensors. For example, an the autonomous vehicle may build a 3D model of its surrounding based on data from its LiDAR, radar, sonar, and cameras, along with a pre-generated map obtained from ride matching system 130 or a third-party system.

In particular embodiments, the autonomous vehicle may be equipped with a processing unit (e.g., one or more CPUs and GPUs), memory, and storage. The autonomous vehicle may thus be equipped to perform a variety of computational and processing tasks, including processing the sensor data, extracting useful information, and operating accordingly. For example, based on images captured by its cameras and a machine-vision model, the autonomous vehicle may identify particular types of objects captured by the images, such as pedestrians, other vehicles, lanes, curbs, and any other objects of interest.

In particular embodiments, the autonomous vehicle may have a navigation system responsible for safely navigating the autonomous vehicle. In particular embodiments, navigation system may take as input any type of sensor data from, e.g., a Global Positioning System (GPS) module, inertial measurement unit (IMU), LiDAR sensors, optical cameras, radio frequency (RF) transceivers, or any other suitable telemetry or sensory mechanisms. Navigation system 846 may also utilize, e.g., map data, traffic data, accident reports, weather reports, instructions, target destinations, and any other suitable information to determine navigation routes and particular driving operations (e.g., slowing down, speeding up, stopping, swerving, etc.). In particular embodiments, the navigation system may use its determinations to control the autonomous vehicle to operate in prescribed manners and to guide the autonomous vehicle to its destinations without colliding into other objects. Example locations for navigation system include inside the cabin or passenger compartment of the autonomous vehicle, near the engine/battery, near the front seats, rear seats, or in any other suitable location.

In particular embodiments, the autonomous vehicle may be equipped with a ride-service computing device, which may be a tablet or other suitable device installed by ride matching system 130 to allow the user to interact with the autonomous vehicle, ride matching system 130, other users, or a third-party systems. In particular embodiments, installation of a ride-service computing device may be accomplished by placing a ride-service computing device inside the autonomous vehicle, and configuring it to communicate with the vehicle via a wire or wireless connection (e.g., via Bluetooth). The autonomous vehicle may include a single or several ride-service computing devices in several different locations within the autonomous vehicle. As an example and not by way of limitation, the autonomous vehicle may include four ride-service computing devices located in the following places: one in front of the front-left passenger seat (e.g., driver's seat in traditional U.S. automobiles), one in front of the front-right passenger seat, one in front of each of the rear-left and rear-right passenger seats. In particular embodiments, ride-service computing device may be detachable from any component of the autonomous vehicle. This may allow users to handle ride-service computing device in a manner consistent with other tablet computing devices. As an example and not by way of limitation, a user may move ride-service computing device to any location in the cabin or passenger compartment of the autonomous vehicle, may hold ride-service computing device in his/her lap, or handle ride-service computing device in any other suitable manner. In particular embodiments, ride-service computing device may include one or more structures and/or one or more functionalities as those described with reference to the provider computing device 714. Although this disclosure describes providing a particular computing device in a particular manner, this disclosure contemplates providing any suitable computing device in any suitable manner.

In some embodiments, provider computing device 718 can include a provider communication device configured to communicate with users, such as drivers, passengers, pedestrians, and other users. In some embodiments, provider communication device 718 can communicate directly with management system 702 or through another provider computing device, such as provider computing device 716. In some embodiments, a requestor computing device can communicate 726 directly with provider communication device 718 over a peer-to-peer connection, Bluetooth connection, NFC connection, ad hoc wireless network, or any other communication channel or connection. Although particular devices are shown as communicating with management system 702 over networks 710 and 712, in various embodiments, management system 702 can expose an interface, such as an application programming interface (API) or service provider interface (SPI) to enable various third parties which may serve as an intermediary between end users and management system 702.

Although requestor/provider management environment 700 is shown with four provider devices and two requestor devices, any number of devices may be supported. The various components shown and described herein may be implemented in hardware, firmware, software, or combinations thereof. Although one embodiment of a requestor/provider management environment is depicted in FIG. 7, this is merely one implementation and not meant to be limiting.

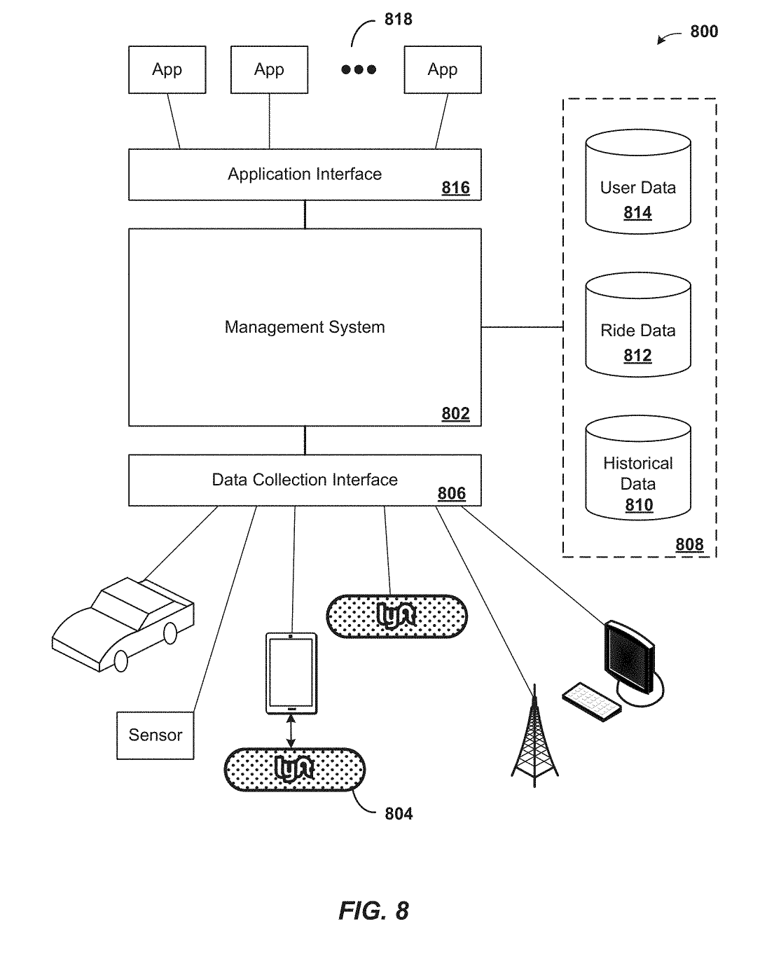

FIG. 8 shows a data collection and application management environment 800, in accordance with various embodiments. As shown in FIG. 8, management system 802 may be configured to collect data from various data collection devices 804 through a data collection interface 806. As discussed above, management system 802 may include one or more computers and/or servers or any combination thereof. Data collection devices 804 may include, but are not limited to, user devices (including provider and requestor computing devices, such as those discussed above), provider communication devices, laptop or desktop computers, vehicle data (e.g., from sensors integrated into or otherwise connected to vehicles), ground-based or satellite-based sources (e.g., location data, traffic data, weather data, etc.), or other sensor data (e.g., roadway embedded sensors, traffic sensors, etc.). Data collection interface 806 can include, e.g., an extensible device framework configured to support interfaces for each data collection device. In various embodiments, data collection interface 806 can be extended to support new data collection devices as they are released and/or to update existing interfaces to support changes to existing data collection devices. In various embodiments, data collection devices may communicate with data collection interface 806 over one or more networks. The networks may include any network or communication protocol as would be recognized by one of ordinary skill in the art, including those networks discussed above.

As shown in FIG. 8, data received from data collection devices 804 can be stored in data store 808. Data store 808 can include one or more data stores, such as databases, object storage systems and services, cloud-based storage services, and other data stores. For example, various data stores may be implemented on a non-transitory storage medium accessible to management system 802, such as historical data store 810, ride data store 812, and user data store 814. Data stores 808 can be local to management system 802, or remote and accessible over a network, such as those networks discussed above or a storage-area network or other networked storage system. In various embodiments, historical data 810 may include historical traffic data, weather data, request data, road condition data, or any other data for a given region or regions received from various data collection devices. Ride data 812 may include route data, request data, timing data, and other ride related data, in aggregate and/or by requestor or provider. User data 814 may include user account data, preferences, location history, and other user-specific data. Although particular data stores are shown, any data collected and/or stored according to the various embodiments described herein may be stored in data stores 808.

As shown in FIG. 8, an application interface 816 can be provided by management system 802 to enable various apps 818 to access data and/or services available through management system 802. Apps 818 can run on various user devices (including provider and requestor computing devices, such as those discussed above) and/or may include cloud-based or other distributed apps configured to run across various devices (e.g., computers, servers, or combinations thereof). Apps 818 may include, e.g., aggregation and/or reporting apps which may utilize data 808 to provide various services (e.g., third-party ride request and management apps). In various embodiments, application interface 816 can include an API and/or SPI enabling third party development of apps 818. In some embodiments, application interface 816 may include a web interface, enabling web-based access to data 808 and/or services provided by management system 802. In various embodiments, apps 818 may run on devices configured to communicate with application interface 816 over one or more networks. The networks may include any network or communication protocol as would be recognized by one of ordinary skill in the art, including those networks discussed above, in accordance with an embodiment of the present disclosure.

Although a particular implementation of environment 800 is shown in FIG. 8, this is for illustration purposes only and not intended to be limited. In some embodiments, environment 800 may include fewer or more components, as would be recognized by one or ordinary skill in the art.

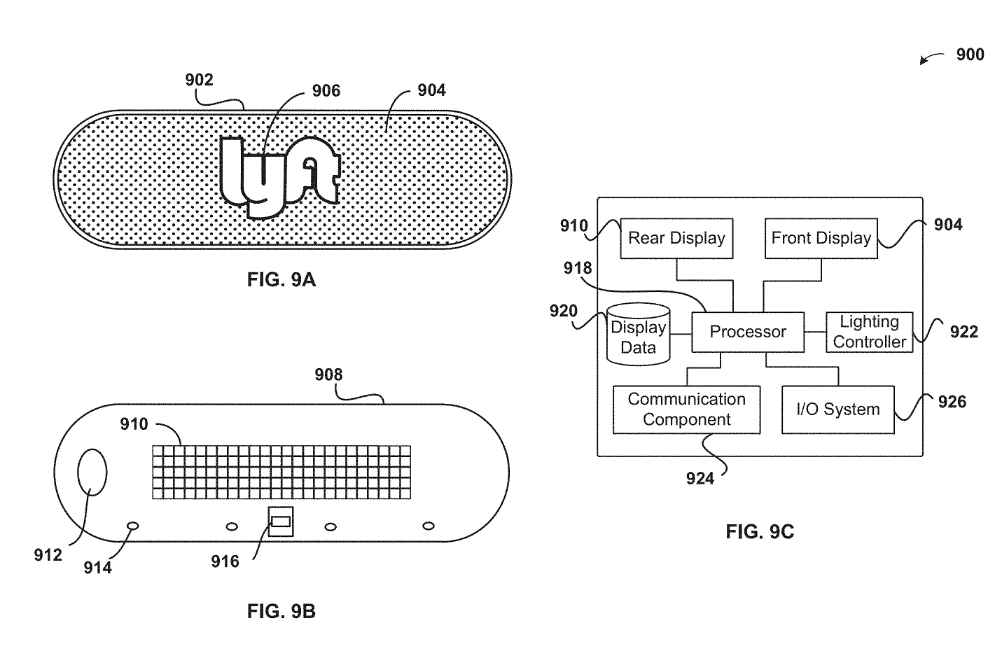

FIGS. 9A-9C show an example provider communication device 1500 in accordance with various embodiments. As shown in FIG. 9A, a front view 902 of provider communication device 900 shows a front display 904. In some embodiments, front display 904 may include a secondary region or separate display 906. As shown in FIG. 9A, the front display may include various display technologies including, but not limited to, one or more liquid crystal displays (LCDs), one or more arrays of light emitting diodes (LEDs), or other display technologies. In some embodiments, the front display may include a cover that divides the display into multiple regions. In some embodiments, separate displays may be associated with each region. The front display 904 can be configured to show colors, patterns, color patterns, or other identifying information to requestors and other users external to a provider vehicle. In some embodiments, the secondary region or separate display 906 may be configured to display the same, or contrasting, information as front display 904.

As shown in FIG. 9B, a rear view 908 of provider communication device 900 shows a rear display 910. Rear display 910, as with front display 904, rear display 910 may include various display technologies including, but not limited to, one or more liquid crystal displays (LCDs), one or more arrays of light emitting diodes (LEDs), or other display technologies. The rear display may be configured to display information to the provider, the requestor, or other users internal to a provider vehicle. In some embodiments, rear display 910 may be configured to provide information to users external to the provider vehicle who are located behind the provider vehicle. As further shown in FIG. 9B, provider communication device may include a power button 912 or other switch which can be used to turn on or off the provider communication device. In various embodiments, power button 912 may be a hardware button or switch that physically controls whether power is provided to provider communication device 900. Alternatively, power button 912 may be a soft button that initiates a startup/shutdown procedure managed by software and/or firmware instructions. In some embodiments, provider communication device 900 may not include a power button 912. Additionally, provider communication device may include one or more light features 914 (such as one or more LEDs or other light sources) configured to illuminate areas adjacent to the provider communication device 900. In some embodiments, provider communication device 900 can include a connector to enable a provider computing device to be connected to the provider communication device 900. In some embodiments, power may be provided to the provider communication device through connector 916.

FIG. 9C shows a block diagram of provider computing device 900. As shown in FIG. 9C, provider communication device can include a processor 918. Processor 918 can control information displayed on rear display 910 and front display 904. As noted, each display can display information to different users, depending on the positioning of the users and the provider communication device. In some embodiments, display data 920 can include stored display patterns, sequences, colors, text, or other data to be displayed on the front and/or rear display. In some embodiments, display data 920 can be a buffer, storing display data as it is received from a connected provider computing device. In some embodiments, display data 920 can include a hard disk drive, solid state drive, memory, or other storage device including information from a management system. In some embodiments, lighting controller 922 can manage the colors and/or other lighting displayed by light features 914. In some embodiments, communication component 924 can manage networking or other communication between the provider communication device 900 and one or more networking components or other computing devices. In various embodiments, communication component 924 can be configured to communicate over Wi-Fi, Bluetooth, NFC, RF, or any other wired or wireless communication network or protocol. In some embodiments, provider communication device 900 can include an input/output system 926 configured to provide output in addition to that provided through the displays and/or to receive inputs from users. For example, I/O system 926 can include an image capture device configured to recognize motion or gesture-based inputs from a user. Additionally, or alternatively, I/O system 926 can include an audio device configured to provide audio outputs (such as alerts, instructions, or other information) to users and/or receive audio inputs, such as audio commands, which may be interpreted by a voice recognition system or other command interface. In some embodiments, I/O system may include one or more input or output ports, such as USB (universal serial bus) ports, lightning connector ports, or other ports enabling users to directly connect their devices to the provider communication device (e.g., to exchange data, verify identity information, provide power, etc.).

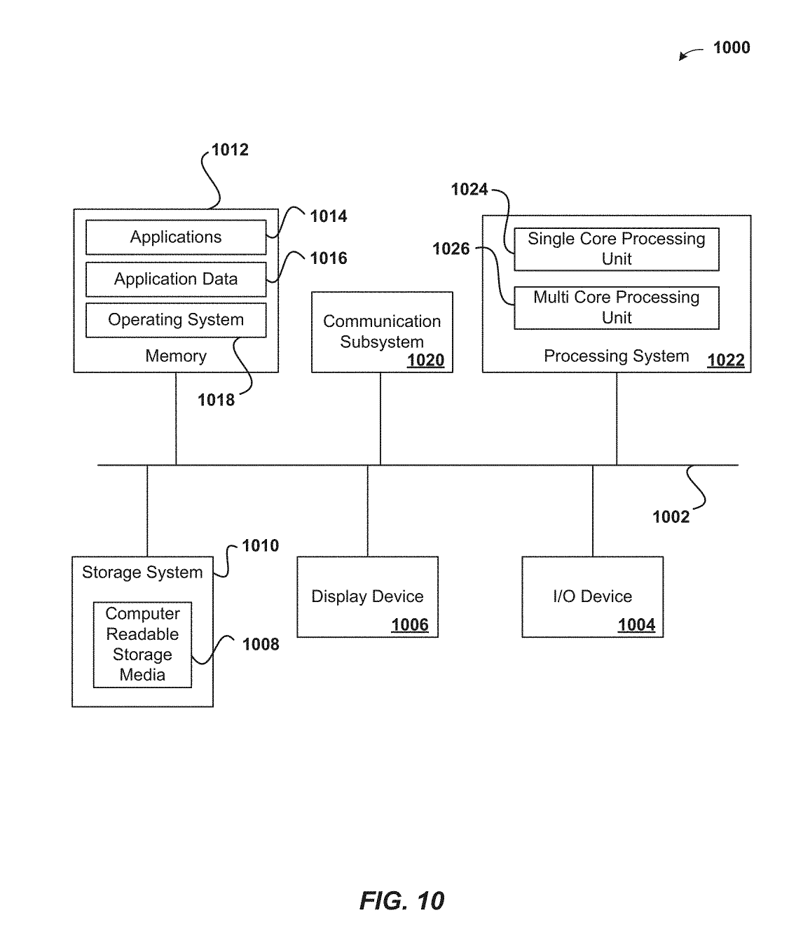

FIG. 10 shows an example computer system 1000, in accordance with various embodiments. In various embodiments, computer system 1000 may be used to implement any of the systems, devices, or methods described herein. In some embodiments, computer system 1000 may correspond to any of the various devices described herein, including, but not limited, to mobile devices, tablet computing devices, wearable devices, personal or laptop computers, vehicle-based computing devices, or other devices or systems described herein. As shown in FIG. 10, computer system 1000 can include various subsystems connected by a bus 1002. The subsystems may include an I/O device subsystem 1004, a display device subsystem 1006, and a storage subsystem 1010 including one or more computer readable storage media 1008. The subsystems may also include a memory subsystem 1012, a communication subsystem 1020, and a processing subsystem 1022.

In system 1000, bus 1002 facilitates communication between the various subsystems. Although a single bus 1002 is shown, alternative bus configurations may also be used. Bus 1002 may include any bus or other component to facilitate such communication as is known to one of ordinary skill in the art. Examples of such bus systems may include a local bus, parallel bus, serial bus, bus network, and/or multiple bus systems coordinated by a bus controller. Bus 1002 may include one or more buses implementing various standards such as Parallel ATA, serial ATA, Industry Standard Architecture (ISA) bus, Extended ISA (EISA) bus, MicroChannel Architecture (MCA) bus, Peripheral Component Interconnect (PCI) bus, or any other architecture or standard as is known in the art.

In some embodiments, I/O device subsystem 1004 may include various input and/or output devices or interfaces for communicating with such devices. Such devices may include, without limitation, a touch screen or other touch-sensitive input device, a keyboard, a mouse, a trackball, a motion sensor or other movement-based gesture recognition device, a scroll wheel, a click wheel, a dial, a button, a switch, audio recognition devices configured to receive voice commands, microphones, image capture based devices such as eye activity monitors configured to recognize commands based on eye movement or blinking, and other types of input devices. I/O device subsystem 1004 may also include identification or authentication devices, such as fingerprint scanners, voiceprint scanners, iris scanners, or other biometric sensors or detectors. In various embodiments, I/O device subsystem may include audio output devices, such as speakers, media players, or other output devices.

Computer system 1000 may include a display device subsystem 1006. Display device subsystem may include one or more lights, such as an one or more light emitting diodes (LEDs), LED arrays, a liquid crystal display (LCD) or plasma display or other flat-screen display, a touch screen, a head-mounted display or other wearable display device, a projection device, a cathode ray tube (CRT), and any other display technology configured to visually convey information. In various embodiments, display device subsystem 1006 may include a controller and/or interface for controlling and/or communicating with an external display, such as any of the above-mentioned display technologies.

As shown in FIG. 10, system 1000 may include storage subsystem 1010 including various computer readable storage media 1008, such as hard disk drives, solid state drives (including RAM-based and/or flash-based SSDs), or other storage devices. In various embodiments, computer readable storage media 1008 can be configured to store software, including programs, code, or other instructions, that is executable by a processor to provide functionality described herein. In some embodiments, storage system 1010 may include various data stores or repositories or interface with various data stores or repositories that store data used with embodiments described herein. Such data stores may include, databases, object storage systems and services, data lakes or other data warehouse services or systems, distributed data stores, cloud-based storage systems and services, file systems, and any other data storage system or service. In some embodiments, storage system 1010 can include a media reader, card reader, or other storage interface to communicate with one or more external and/or removable storage devices. In various embodiments, computer readable storage media 1008 can include any appropriate storage medium or combination of storage media. For example, computer readable storage media 1008 can include, but is not limited to, any one or more of random access memory (RAM), read only memory (ROM), electronically erasable programmable ROM (EEPROM), flash memory or other memory technology, optical storage (e.g., CD-ROM, digital versatile disk (DVD), Blu-ray® disk or other optical storage device), magnetic storage (e.g., tape drives, cassettes, magnetic disk storage or other magnetic storage devices). In some embodiments, computer readable storage media can include data signals or any other medium through which data can be sent and/or received.

Memory subsystem 1012 can include various types of memory, including RAM, ROM, flash memory, or other memory. Memory 1012 can include SRAM (static RAM) or DRAM (dynamic RAM). In some embodiments, memory 1012 can include a BIOS (basic input/output system) or other firmware configured to manage initialization of various components during, e.g., startup. As shown in FIG. 10, memory 1012 can include applications 1014 and application data 1010. Applications 1014 may include programs, code, or other instructions, that can be executed by a processor. Applications 1014 can include various applications such as browser clients, location management applications, ride management applications, data management applications, and any other application. Application data 1016 can include any data produced and/or consumed by applications 1014. Memory 1012 can additionally include operating system 1018, such as macOS®, Windows®, Linux®, various UNIX® or UNIX- or Linux-based operating systems, or other operating systems.

System 1000 can also include a communication subsystem 1020 configured to facilitate communication between system 1000 and various external computer systems and/or networks (such as the Internet, a local area network (LAN), a wide area network (WAN), a mobile network, or any other network). Communication subsystem 1020 can include hardware and/or software to enable communication over various wired (such as Ethernet or other wired communication technology) or wireless communication channels, such as radio transceivers to facilitate communication over wireless networks, mobile or cellular voice and/or data networks, WiFi networks, or other wireless communication networks. For example, the communication network is shown as communication network 170 in FIG. 1. Additionally, or alternatively, communication subsystem 1020 can include hardware and/or software components to communicate with satellite-based or ground-based location services, such as GPS (global positioning system). In some embodiments, communication subsystem 1020 may include, or interface with, various hardware or software sensors. The sensors may be configured to provide continuous or and/or periodic data or data streams to a computer system through communication subsystem 1020

As shown in FIG. 10, processing system 1022 can include one or more processors or other devices operable to control computing system 1000. Such processors can include single core processors 1024, multi core processors, which can include central processing units (CPUs), graphical processing units (GPUs), application specific integrated circuits (ASICs), digital signal processors (DSPs) or any other generalized or specialized microprocessor or integrated circuit. Various processors within processing system 1022, such as processors 1024 and 1026, may be used independently or in combination depending on application.

Various other configurations are may also be used, with particular elements that are depicted as being implemented in hardware may instead be implemented in software, firmware, or a combination thereof. One of ordinary skill in the art will recognize various alternatives to the specific embodiments described herein.

The specification and figures describe particular embodiments which are provided for ease of description and illustration and are not intended to be restrictive. Embodiments may be implemented to be used in various environments without departing from the spirit and scope of the disclosure.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A method comprising:
providing, by a dynamic transportation matching system, a scheduling interface for display by a provider computing device, the scheduling interface including one or more scheduling options;
receiving, from the provider computing device by way of the scheduling interface, a selection of at least one scheduling option, the at least one scheduling option indicating a future destination and a future time;
receiving, by the dynamic transportation matching system, a request associated with a request location and a destination location;
determining, in response to receiving the request, that completing the request from the request location to the destination location would allow a provider associated with the provider computing device to arrive at the future destination by the future time; and
sending, based on determining that completing the request would allow the provider to arrive at the future destination by the future time, the request to the provider computing device.

2. The method of claim 1, wherein the one or more scheduling options comprise one or more available scheduled rides.

3. The method of claim 1, wherein determining that completing the request would allow the provider to arrive at the future destination by the future time comprises:
determining an estimated arrival time for the provider to arrive at the future destination if the provider completes the request; and
comparing the estimated arrival time with the future time to determine that, based on the estimated arrival time, the provider will arrive at the future destination by the future time.

4. The method of claim 3, further comprising determining the estimated arrival time by determining an amount of time to travel from a current location of the provider computing device to a pickup location associated with the request.

5. The method of claim 3, further comprising determining the estimated arrival time further by determining, for a route from a current location of the provider to a pickup location associated with the request, one or more of traffic information, weather information, route distance information, road condition information, or road closure information.

6. The method of claim 1, wherein providing the scheduling interface to the provider computing device comprises:
determining a relevance score of each of a plurality of scheduling options for the provider;
ranking the plurality of scheduling options based on the determined relevance score for each of the plurality of scheduling options; and
selecting the one or more scheduling options for display within the scheduling interface based on the ranking of the plurality of scheduling options.

7. The method of claim 1, wherein providing the scheduling interface to the provider computing device comprises filtering overlapping scheduling options, the overlapping scheduling options conflicting in request time such that only one of the overlapping scheduling options could be completed by the provider.

8. The method of claim 1, wherein providing the scheduling interface to the provider computing device comprises:
determining a value of each of a plurality of scheduling options for the provider, the value being based on at least one of an estimated amount of payment or a travel distance;
ranking the plurality of scheduling options based on the determined value for each of the plurality of scheduling options; and
selecting the one or more scheduling options for display within the scheduling interface based on the ranking of the plurality of scheduling options.

9. The method of claim 1, further comprising:
receiving a second request;
determining, in response to receiving the second request, that completing the second request would prevent the provider from arriving at the future destination by the future time; and
in response to determining that completing the second request would prevent the provider from arriving at the future destination by the future time, refraining from sending the second request to the provider computing device.

10. The method of claim 9, wherein determining that completing the second request would prevent the provider from arriving at the future destination by the future time comprises:
determining an estimated arrival time for the provider to arrive at the future destination if the provider completes the second request; and
comparing the estimated arrival time with the future time to determine that, based on the estimated arrival time, the provider will not arrive at the future destination by the future time.

11. A non-transitory computer readable medium comprising instructions that, when executed by at least one processor, cause a computer device to:
provide, by a dynamic transportation matching system, a scheduling interface for display by a provider computing device, the scheduling interface including one or more scheduling options;
receive, from the provider computing device by way of the scheduling interface, a selection of at least one scheduling option, the at least one scheduling option indicating a future destination and a future time;
receive, by the dynamic transportation matching system, a request associated with a request location and a destination location;
determine, in response to receiving the request, that completing the request from the request location to the destination location would allow a provider associated with the provider computing device to arrive at the future destination by the future time; and
send, based on determining that completing the request would allow the provider to arrive at the future destination by the future time, the request to the provider computing device.

12. The non-transitory computer readable medium of claim 11, wherein the one or more scheduling options comprise one or more available scheduled rides.

13. The non-transitory computer readable medium of claim 11, wherein the instructions cause the computer device to determine that completing the request would allow the provider to arrive at the future destination by the future time by:
determining an estimated arrival time for the provider to arrive at the future destination if the provider completes the request; and
comparing the estimated arrival time with the future time to determine that, based on the estimated arrival time, the provider will arrive at the future destination by the future time.

14. The non-transitory computer readable medium of claim 13, further comprising instructions that, when executed by the at least one processor, cause the computer device to determine the estimated arrival time by determining a distance from a location of the provider to the pickup location associated with the request.

15. The non-transitory computer readable medium of claim 13, wherein the instructions cause the computer device to provide the scheduling interface to the provider computing device by:
determine a relevance score of each of a plurality of scheduling options for the provider;
rank the plurality of scheduling options based on the determined relevance score for each of the plurality of scheduling options; and
select the one or more scheduling options for display within the scheduling interface based on the ranking of the plurality of scheduling options.

16. The non-transitory computer readable medium of claim 11, further comprising instructions that, when executed by the at least one processor, cause the computer device to:
receive a second request;
determine, in response to receiving the second request, that completing the second request would prevent the provider from arriving at the future destination by the future time; and
in response to determining that completing the second request would prevent the provider from arriving at the future destination by the future time, refrain from sending the second request to the provider.

17. The non-transitory computer readable medium of claim 16, wherein the instructions cause the computer device to determine that completing the second request would prevent the provider from arriving at the future destination by the future time by:
determining an estimated arrival time for the provider to arrive at with the future destination if the provider completes the second request; and
comparing the estimated arrival time with the future time to determine that, based on the estimated arrival time, the provider will not arrive at the future destination by the future time.

18. A system comprising:
at least one processor; and
a non-transitory computer readable medium comprising instructions that, when executed by at the least one processor, cause the system to:
provide, by a dynamic transportation matching system, a scheduling interface for display by a provider computing device, the scheduling interface including one or more scheduling options;
receive, from the provider computing device by way of the scheduling interface, a selection of at least one scheduling option, the at least one scheduling option indicating a future destination and a future time;
receive, by the dynamic transportation matching system, a request associated with a request location and a destination location;
determine, in response to receiving the request, that completing the request from the request location to the destination location would allow a provider associated with the provider computing device to arrive at the future destination by the future time; and
send, based on determining that completing the request would allow the provider to arrive at the future destination by the future time, the request to the provider computing device.

19. The system of claim 18, wherein the one or more scheduling options comprise one or more available scheduled rides.

20. The system of claim 18, wherein the instructions cause the system to determine that completing the request would allow the provider to arrive at the future destination by the future time by:
determining an estimated arrival time for the provider to arrive at with the future destination if the provider completes the request; and
comparing the estimated arrival time with the future time to determine that, based on the estimated arrival time, the provider will arrive at the future destination by the future time.
